(19) United States
(12) Patent Application Publication
(10) Pub. No.: US 2013/0089146 A1
(43) Pub. Date: Apr. 11, 2013

(54) INFORMATION PROCESSING APPARATUS AND INFORMATION PROCESSING METHOD

(71) Applicants: Junichi Matsumoto, Kanagawa (JP); Takashi Fukuyama, Tokyo (JP)

(72) Inventors: Junichi Matsumoto, Kanagawa (JP); Takashi Fukuyama, Tokyo (JP)

(21) Appl. No.: 13/699,091

(22) PCT Filed: Jun. 22, 2011
(86) PCT No.: PCT/JP2011/064290

§ 371 Date: Nov. 20, 2012

(30) Foreign Application Priority Data
Jun. 25, 2010 (JP) 2010-144907

(51) Int. Cl. H04N 7/32

(52) U.S. Cl. CPC H04N 19/00569
USPC 375/240.12

(57) ABSTRACT

To efficiently use anchor information. When anchor information to be used in a decoding process of a target block to be decoded does not satisfy an identity condition with anchor information used for a previous block, anchor information of an anchor block corresponding to the target block to be decoded is acquired from an anchor information storage unit. When the identity condition is satisfied, the anchor information of the previous block is continuously used. A motion vector is calculated using the acquired anchor information or the anchor information to be continuously used. Motion compensation is performed based on the calculated motion vector, and prediction image data is generated. Further, decoded image data is generated using the prediction image data

### TECHNICAL FIELD

The present invention relates to an information processing apparatus and an information processing method. More specifically, an object of the present invention is to provide an information processing apparatus and an information processing method capable of efficiently using anchor information.

### BACKGROUND ART

In recent years, a device that treats image information in a digital format, and at that time, efficiently transmits and accumulates the information, for example, a device conformable to a method such as MPEG wherein the information is compressed by orthogonal transformation such as discrete cosine transform and by motion compensation has been spreading in broadcast stations or at home.

Especially, MPEG2 (ISO/IEC13818-2) is defined as a general purpose image coding method, and is currently widely used in a wide range of applications for professional use or for consumer use.

Also, a standard called H.26L (ITU-T Q6/16 VCEG) has been standardized for the purpose of image coding of a teleconference and the like. It is known that, despite of requiring a larger amount of computation in coding and decoding than a conventional coding method such as MPEG2 and MPEG4, H.26L is capable of realizing higher coding efficiency. Also, currently, as a part of MPEG4 activities, standardization of realizing higher coding efficiency has progressed as Joint Model of Enhanced-Compression Video Coding based on this H.26L, and has become an international standard under the name of H.264 and MPEG-4 Part 10 (hereinafter, described as “H.264/AVC (advanced video coding)”).

In an inter prediction process in H.264AVC method, when a motion vector of a current block is introduced, a prediction mode that uses an anchor picture, for example, a skip mode or a direct mode (hereinafter, referred to as “skip/direct mode”) is defined. Further, Patent Document 1 discloses an inter prediction process using such an anchor picture.

### CITATION LIST

### Patent Document

Patent Document 1: Japanese Patent Application Laid-open No. 2009-55519

### SUMMARY OF THE INVENTION

### Problems to Be Solved by the Invention

By the way, the anchor picture is a picture that is referenced by a target picture to be decoded, and a picture decoded at a certain point may become the anchor picture of a picture to be subsequently decoded. Therefore, anchor information of a picture likely to be referenced as the anchor picture is generated and stored in a memory, and in the skip/direct mode, the anchor information is read out and a decoding process is performed. Note that the anchor information has a motion vector of an anchor block in the anchor picture and a reference index for identifying the anchor block in the anchor picture.

Therefore, as the size of an image (the number of pixels in the horizontal and vertical directions) becomes larger, the number of blocks increases. Therefore, a data amount of the anchor information stored in the memory increases. A large-capacity memory is required, accordingly. Further, if a prediction mode that uses the anchor information increases, access to the anchor information increases.

Therefore, the present invention provides an information processing apparatus and an information processing method capable of efficiently using the anchor information.

### Solutions to Problems

A first aspect of the present invention is an information processing apparatus, including: an anchor information storage unit configured to store anchor information; and an image decoding unit configured to acquire anchor information of an anchor block corresponding to a target block to be decoded from the anchor information storage unit when anchor information to be used in a decoding process of the target block to be decoded does not satisfy an identify condition with anchor information used for a previous block, to allow the anchor information used for the previous block to be continuously used when the identity condition is satisfied, and to perform the decoding process using the acquired anchor information or the anchor information allowed to be continuously used.

In the present invention, acquisition of the anchor information or continuous use of the anchor information of a previous block is determined based on, for example, identity identification information that determines whether the anchor information to be used in a decoding process of a target block to be decoded satisfies an identity condition with the anchor information used for a previous block. That is, the anchor information of an anchor block corresponding to the target block to be decoded is acquired from an anchor information storage unit when it is determined that the identity condition is not satisfied based on the identity identification information. Meanwhile, the anchor information used for the previous block is continuously used when it is determined that the identity condition is satisfied. A decoding process is performed using the acquired anchor information or the anchor information to be continuously used.

With respect to a picture to be used as an anchor picture and having being subjected to a decoding process in an image decoding unit, the identity identification information is information generated based on anchor information, generated for each block of the picture, or information generated based on anchor information used at coding of a target block to be decoded and anchor information used at coding of a previous block. For example, the identity identification information is an identity flag indicating whether the anchor information can be determined identical to the anchor information of the previous block, or an identity count value indicating the number of successive blocks whose anchor information can foe considered identical.

When the identity flag is generated at decoding, the generated identity flag is stored in a memory separately provided from the anchor information storage unit. When the identity flag is generated at coding, the generated identity flag is included in a coded stream. Also, when the identity count value is generated at decoding, the generated identity count value is stored in the anchor information storage unit with the anchor information in which the identity count value indicates a succession.

A second aspect of the present invention is an information processing method, including the steps of: acquiring anchor information of an anchor block corresponding to a target block to be decoded from an anchor information storage unit for storing anchor information when anchor information to be used in a decoding process of the target block to be decoded does not satisfy an identity condition with anchor information used for a previous block; continuously using the anchor information used for the previous block when the identity condition is satisfied; and performing the decoding process using the acquired anchor information or the anchor information to be continuously used.

### Effects of the Invention

According to the present invention, when anchor information to be used in a decoding process of a target block to be decoded does not satisfy an identity condition with anchor information used for a previous block, anchor information of an anchor block corresponding to the target block to be decoded is acquired from an anchor information storage unit. Also, when the identity condition is satisfied, the anchor information used for the previous block is continuously used. The decoding process is performed using the acquired anchor information or the anchor information to be continuously used. Therefore, it is not necessary to acquire the anchor information of the corresponding anchor block from the anchor information storage unit for each target block to be decoded, whereby the anchor information can be efficiently used.

### BRIEF DESCRIPTION OF DRAWINGS

FIG. 1 is a diagram showing a configuration of an image decoding apparatus.

FIG. 2 is a flowchart showing an image decoding process operation.

FIG. 3 is a flowchart showing a prediction process.

FIG. 4 is a diagram exemplarily showing an acquisition operation of anchor information.

FIG. 5 is a diagram showing a case where both of successive blocks require the anchor information.

FIG. 6 is a flowchart showing an operation of a case where an identity flag is generated.

FIG. 7 is a diagram exemplarily showing a generation result of the identity flag.

FIG. 8 is a diagram showing an operation of a case where the anchor information is read out using the identity flag.

FIG. 9 is a flowchart showing an operation of a case where an identity count value is generated. A diagram showing S.

FIG. 10 is a diagram exemplarily showing a generation result of the identity count value.

FIG. 11 is a diagram showing an operation of a case where the anchor information is read out using the identity count value.

FIG. 12 is a diagram showing a configuration of an image coding apparatus.

FIG. 13 is a diagram exemplarily showing a configuration part regarding generation of identity identification information.

FIG. 14 is a flowchart showing an image coding process operation.

FIG. 15 is a flowchart showing an operation of a case where the identity flag is generated.

FIG. 16 is a diagram exemplarily showing a generation result of the identity flag.

FIG. 17 is an example illustrating a data amount of the anchor information.

FIG. 18 is a flowchart showing an outline operation for calculating a motion vector in a spatial direct mode.

FIG. 19 is a flowchart showing an outline operation for calculating a motion vector in a temporal direct mode.

FIG. 20 is a diagram exemplarily showing a schematic configuration of a television apparatus.

FIG. 21 is a diagram exemplarily showing a schematic configuration of a mobile phone.

FIG. 22 is a diagram exemplarily showing a schematic configuration of a recording/reproducing apparatus.

FIG. 23 is a diagram exemplarily showing a schematic configuration of an image pickup apparatus.

### MODE FOR CARRYING OUT THE INVENTION

Embodiments incorporating the invention will be herein described. In an inter prediction mode and when in a skip/direct mode, a decoding process is performed using anchor information of an anchor block corresponding to a target block to be decoded. Therefore, if a block in the skip/direct mode increases, access to the anchor information increases. Meanwhile, in an anchor picture, motion vectors of anchor blocks are often identical between adjacent anchor blocks. For example, each anchor block positioned in an. image of a moving body has an identical motion vector.

Therefore, when anchor information to be used in a decoding process of a target block to be decoded satisfies an identity condition with anchor information used for a previously decoded block (previous block), the present invention performs the decoding process by continuously using already acquired anchor information based on identity of successive anchor information so that access frequency to a memory is reduced and the anchor information can be efficiently used. Further, the present invention is not only applied to H. 264/AVC method but also applied to a new method that expands the size of a macroblock. Note that the description will be given in the following order.
1. A decoding process using identity of anchor information
2. A case where identity of anchor information is determined at decoding
3. A case where identity of anchor information is determined at coding
4. Comparison of identity of anchor information generated at decoding and at coding
5. A case of a software process
6. An example applied to electronic devices

### [1. A Decoding Process Using Identity of Anchor Information]

A case where a decoding process is performed using identity of anchor information in an information processing apparatus will be described.

### [1-1. A Configuration of an Image Decoding Apparatus]

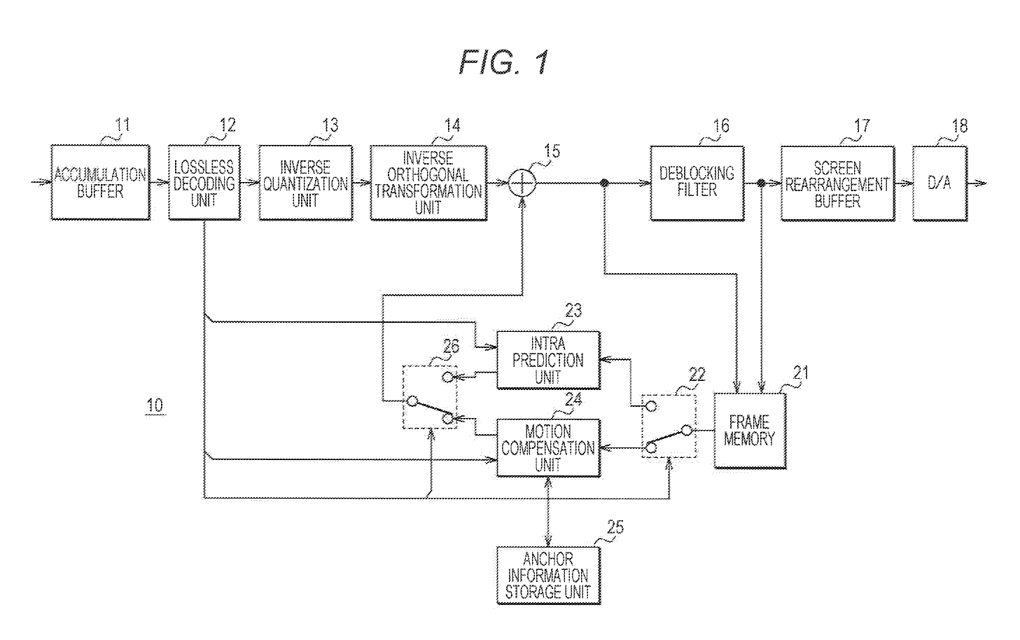

FIG. 1 shows a configuration, of an image decoding apparatus 10. The image decoding apparatus 10 is an information processing apparatus that performs a decoding process, performs the decoding process using a stream (coded stream) generated by performing a coding process of image data, and generates image data before a coding process. Also, the image decoding apparatus 10 acquires, when anchor information to be used in a decoding process of a target block to be decoded does not satisfy an identity condition with anchor information used for a previous block, anchor information of an anchor block corresponding to the target block to be decoded from an anchor information storage unit. The image decoding apparatus 10 determines; when the identity condition is satisfied, that the anchor information used for the previous block is to be continuously used and performs the decoding process using the acquired anchor information or the anchor information determined to be continuously used.

The image decoding apparatus 10 includes an accumulation buffer 11, a lossless decoding unit 12, an inverse quantization unit 13, an inverse orthogonal transformation unit 14, an adding unit 15, a deblocking filter 16, and a screen rearrangement buffer 17. Further, the image decoding apparatus 10 includes a frame memory 21, selectors 22 and 26, an intra prediction, unit 23, and a motion compensation unit 24. Further, an anchor information storage unit 25 that stores anchor information is provided.

A coded stream generated by coding an input image is supplied to the accumulation buffer 11 of the image decoding apparatus 10 via a predetermined transmission line or a recording medium.

The accumulation buffer 11 accumulates the transmitted coded stream. The lossless decoding unit 12 decodes the coded stream supplied from the accumulation buffer 11.

The lossless decoding unit 12 performs processes such as various length decoding or arithmetic decoding with respect to the coded stream supplied from the accumulation buffer 11 and outputs a quantized orthogonal transformation coefficient to the inverse quantization unit 13. Also, the lossless decoding unit 12 outputs, to the intra prediction unit 23 and the motion compensation unit 24, prediction mode information such as a motion vector obtained by decoding header information of the coded stream.

The inverse quantization unit 13 inversely quantizes the quantization data, decoded in the lossless decoding unit 12 by a method corresponding to the quantization method used in an image coding apparatus. The inverse orthogonal transformation unit 14 inversely orthogonally transforms an output from the inverse quantization unit 13 by a method corresponding to an orthogonal transformation method used in the image coding apparatus and outputs transformed data to the adding unit 15.

The adding unit 15 adds the data after the inverse orthogonal transformation and prediction image data supplied from the selector 26 to generate decoded image data and outputs the generated data to the deblocking filter 16 and the frame memory 21.

The deblocking filter 16 performs a filtering process with respect to the decoded image data supplied from the adding unit 15 to remove block distortion, supplies the filtered data to the frame memory 21 and allows the frame memory 21 to accumulate the filtered data as well as outputs the filtered data to the screen rearrangement buffer 17,

The screen rearrangement buffer 17 rearranges images. The screen rearrangement buffer 17 rearranges the order of frames that have been arranged in the order of coding in the image coding apparatus to the order of an original display and outputs the image data to the D/A conversion unit 18.

The D/A conversion unit 18 performs D/A conversion of the image data supplied from the screen rearrangement buffer 17 and outputs converted data to a display (not shown) to display an image.

The frame memory 21 holds the decoded image data before the filtering process supplied from the adding unit 15 and the decoded image data after the filtering process supplied, from the deblocking filter 16.

The selector 22 supplies the decoded image data before the filtering process read out from the frame memory 21 to the intra prediction unit 23 when a prediction block subjected to an intra prediction is decoded based on the prediction mode information supplied from the lossless decoding unit 12. Also, the selector 22 supplies the decoded image data after the filtering process read, out from, the frame memory 21 to the motion compensation unit 24 when a prediction block subjected to an inter prediction is decoded based on the prediction mode information supplied from the lossless decoding unit 12.

The intra prediction unit 23 performs an intra prediction process indicated in the prediction mode information supplied from the lossless decoding unit 12 and generates prediction image data, The intra prediction unit 23 outputs the generated prediction image data to the selector 26.

The motion compensation unit 24 performs an inter prediction process based on the prediction mode information supplied from the lossless decoding unit 12 to generate prediction image data. The motion compensation unit 24 calculates a motion vector of a target block to be decoded based on the prediction mode information. Also, the motion compensation unit 24 uses decoded image data indicated in reference picture information included in the prediction mode information from among the decoded image data stored in the frame memory 21. Further, the motion compensation unit 24 performs motion compensation using the decoded image data based on the calculated motion vector and the prediction mode indicated in the prediction mode information and generates prediction image data. The motion compensation unit 24 outputs the generated prediction image data to the selector 26.

The anchor information storage unit 25 stores anchor information required when the motion compensation unit 24 performs a decoding process of a target block to be decoded in the skip/direct mode. Note that, as the anchor information, information generated in the motion compensation unit 24 in the decoding process of a picture likely to be referenced as an anchor picture is used.

The selector 26 supplies the prediction image data generated in the intra prediction unit 23 to the adding unit 15. Also, the selector 26 supplies the prediction image data generated in the motion compensation unit 24 to the adding unit 15.

### [1-2. Operation of an Image Decoding Apparatus]

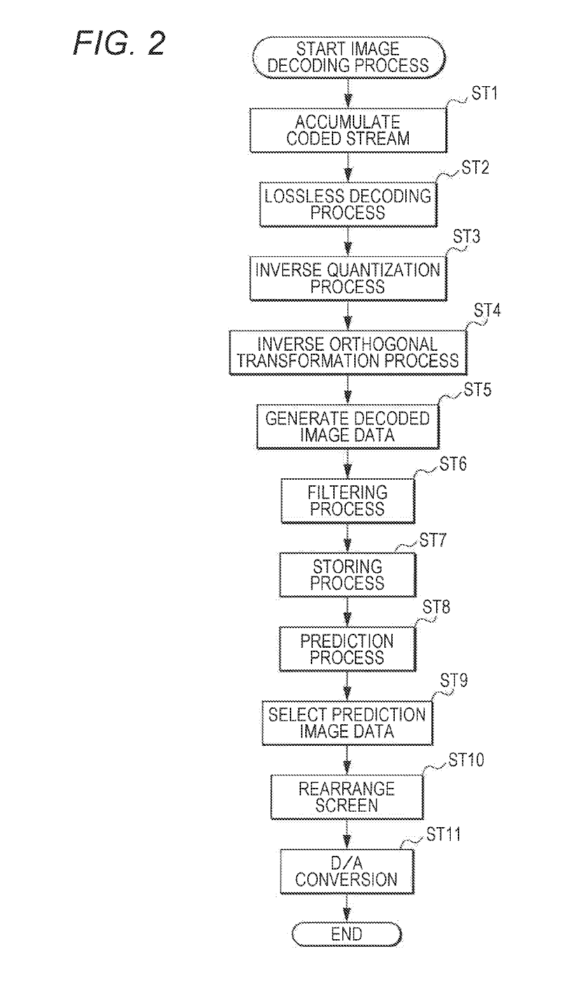

FIG. 2 is a flowchart showing an image decoding process operation performed in the image decoding apparatus 10.

In step ST1, the accumulation buffer 11 accumulates a transmitted coded stream. In step ST2, the lossless decoding unit 12 performs a lossless decoding process. The lossless decoding unit 12 decodes the coded stream supplied from the accumulation buffer 11. The lossless decoding unit 12 performs processes such as various length decoding or arithmetic decoding with respect to the coded stream and outputs obtained quantization data to the inverse quantization unit 13. Also, the lossless decoding unit 12 outputs prediction mode information obtained by decoding header information of the coded stream to the intra prediction unit 23 and the motion compensation unit 24. Note that the prediction mode information includes information regarding a motion vector or a reference picture to be used in an inter prediction as well as prediction modes in an intra prediction or in the inter prediction.

In step ST3, the inverse quantization unit 13 performs an inverse quantisation process. The inverse quantization unit 13 inversely quantizes the quantization data supplied from the lossless decoding unit 12 and outputs obtained transformation coefficient data to the inverse orthogonal transformation unit 14. Note that the inverse quantization performs a process of returning the quantization data into transformation coefficient data before quantization in an image coding process.

In step ST4, the inverse orthogonal transformation unit 14 performs an inverse orthogonal transformation process. The inverse orthogonal transformation unit 14 inversely orthogonally transforms the transformation coefficient data supplied from the inverse quantization unit 13 and outputs obtained image data to the adding unit 15. Note that the inverse orthogonal transformation is a process of returning the transformation coefficient data into image data before orthogonal transformation in an image coding process.

In step ST5, the adding unit 15 generates decoded image data. The adding unit 15 adds the data obtained by adding the inverse orthogonal transformation process and prediction image data selected in step ST9 described below to generate decoded image data. In this way, an original image is decoded.

In step ST6, the deblocking filter 16 performs a filtering process. The deblocking filter 16 filters the decoded image data output from, the adding unit 15 to remove block distortion included in a decoded image.

In step ST7, the frame memory 21 stores the decoded image data.

In step ST8, the intra prediction unit 23 and the motion compensation unit 24 performs a prediction process. The intra prediction unit 23 and the motion compensation unit 24 respectively perform prediction processes in accordance with the prediction mode information supplied from the lossless decoding unit 12.

That is, when the prediction mode information of an intra prediction is supplied from the lossless decoding unit 12, the intra prediction unit 23 performs an intra prediction process in the prediction mode indicated in the prediction mode information and generates prediction image data. Meanwhile, when the prediction mode information of an inter prediction is supplied from the lossless decoding unit 12, the motion, compensation unit 24 performs motion compensation based on the prediction mode indicated in the prediction mode information, the information regarding the motion vector and the reference picture, and the like and generates prediction image data.

In step ST9, the selector 26 selects the prediction image data. That is, the selector 26 selects a prediction image supplied from the intra prediction unit 23 and the prediction image data generated in the motion compensation unit 24 and supplies the selected data to the adding unit 15, and, in step ST5, allows the adding unit 15 to add the selected data to the output of the inverse orthogonal transformation unit 14 as described above.

In step ST10, the screen rearrangement buffer 17 performs image rearrangement. That is, the screen rearrangement buffer 17 rearranges the order of frames that have been arranged for coding to the order of an original display.

In step ST11, the D/A conversion unit 18 performs D/A conversion of image data from the screen rearrangement buffer 17. This image is output to a display (not shown) and is displayed.

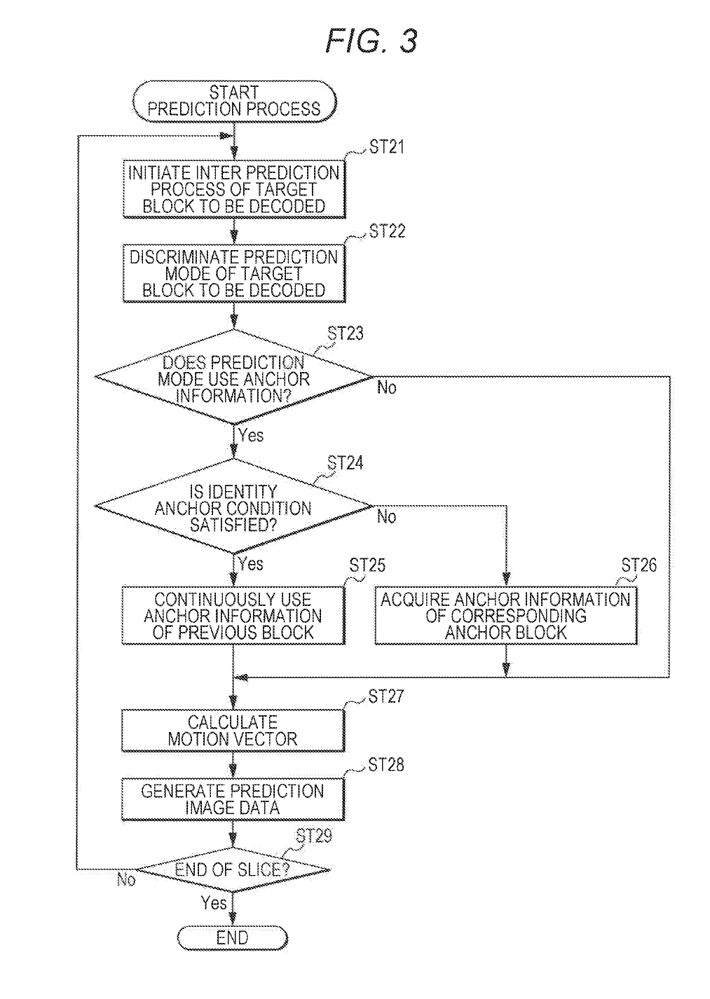

FIG. 3 is a flowchart showing a prediction process performed in the motion compensation unit 24. Note that the inter prediction mode or the intra prediction mode can be set in a unit of a picture or of a slice, and FIG. 3 shows a case where the inter prediction mode is set in a unit of a slice.

In step ST21, the motion compensation unit 24 starts an inter prediction process of a target block to be decoded and proceeds to step ST22.

In step ST22, the motion compensation unit 24 determines a prediction mode of the target block to be decoded. The motion compensation unit. 24 determines the prediction mode based on the prediction mode information supplied from the lossless decoding unit 12 and proceeds to step ST23.

In step ST23, the motion compensation unit 24 determines whether the prediction mode is a mode that uses anchor information. The motion compensation unit 24 proceeds to step ST24 when the prediction mode determined in step ST22 is a mode that uses anchor information, that is, the skip/direct mode, and proceeds to step ST27 when the prediction mode is other mode.

In step ST24, the motion compensation unit 24 determines whether an identity anchor condition is satisfied. The motion compensation unit 24 proceeds to step ST25 when anchor information of an anchor block corresponding to the target block to be decoded can be considered identical to anchor information used for a previous block based on identity identification information described below. Meanwhile, when the anchor information of the target block to be decoded cannot be considered identical and the previous block is processed in the prediction mode without using anchor information, the motion compensation unit 24 proceeds to step ST26.

In step ST25, the motion compensation unit 24 continuously uses the anchor information of the previous block. The motion compensation unit 24 continuously uses the anchor information used for the previous block as the anchor information of the target block to be decoded and proceeds to step ST27. In this way, it is not necessary for the motion compensation unit 24 to read out the anchor information from the anchor information storage unit 25 by continuously using the already read out anchor information.

In step ST26, the motion compensation unit 24 acquires anchor information of a corresponding anchor block. The motion compensation unit 24 reads out the anchor information generated for the anchor block corresponding to the target block to be decoded from the anchor information storage unit 25 and proceeds to step ST27.

In step ST27, the motion compensation unit 24 calculates a motion vector. The motion compensation unit 24 calculates the motion vector of the target block to be decoded using a motion vector indicated in the anchor information used for the previous block or in the anchor information read out from the anchor information storage unit 25 when the prediction mode is a mode that uses anchor information. Meanwhile, when the prediction mode is a mode without using anchor information, the motion compensation unit 24 adds a prediction motion vector such as a median of motion vectors of adjacent blocks as the prediction motion vector to a difference motion vector indicated in the prediction mode information to produce the motion vector of the target block to be decoded. In this way, the motion compensation unit 24 calculates the motion vector in accordance with the prediction mode and proceeds to step ST28.

In step ST28, the motion compensation unit 24 generates prediction image data. The motion compensation unit 24 performs motion compensation with respect to image data of a reference image stored in a frame memory based on the motion vector calculated in step ST27, generates prediction image data, and proceeds to step ST29.

In step ST29, the motion compensation unit 24 determines whether the end of a slice. The motion compensation unit 24 returns to step ST21 when it is not the end of a slice and performs a process of a next block. Also, the motion compensation unit 24 terminates the inter prediction process of the slice when it is the end of the slice.

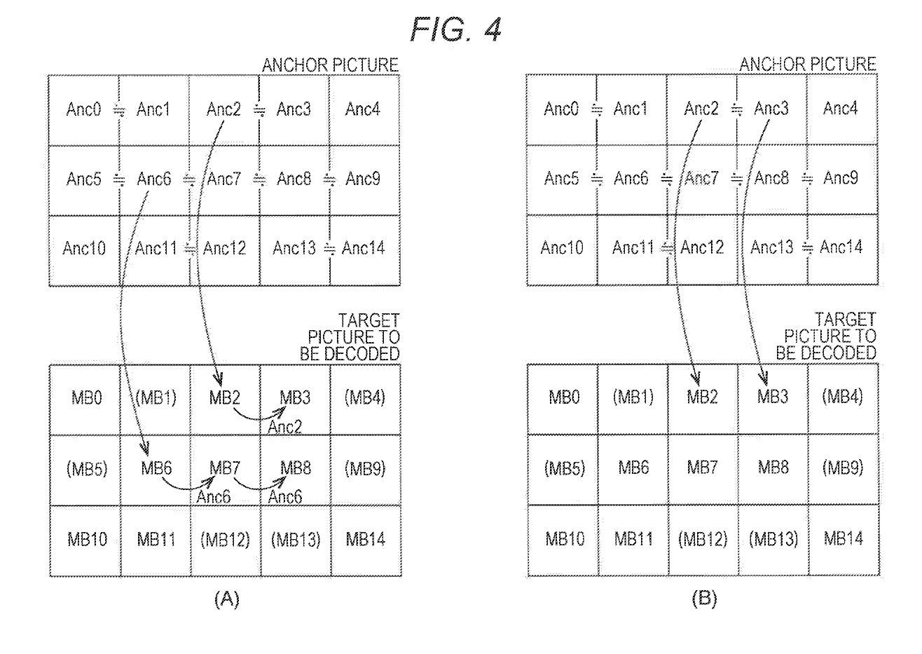

FIG. 4 is a diagram exemplarily showing an acquisition operation of anchor information performed in the motion compensation unit 24, FIG. 4(A) is a diagram illustrating an acquisition operation of anchor information using identity of anchor information. Note that FIG. 4(B) shows a conventional acquisition operation of anchor information without using identity of anchor information.

In FIGS. 4(A) and 4(B), for example, blocks MB0, MB2, MB3, MB6, MB7, MB8, MB10, MB11, and MB14 in the target picture to be decoded is a block in the skip/direct mode that uses anchor information. Also, bracketed blocks MB1, MB4, MB5, MB9, MB12, and MB13 are in other prediction mode without using anchor information.

Anchor information Anc0 in the anchor picture is anchor information of an anchor block corresponding to the block MB0. Similarly, anchor information Anc1 to Anc15 is anchor information of anchor blocks corresponding to the blocks MB1 to MB15.

Further, for example, the anchor information Anc3 is information that can be considered identical to the anchor information Anc2. Similarly, the anchor information Anc7 and Anc8 is information that can be considered identical to the anchor information Anc6.

As shown in FIG. 4(A), the motion compensation unit 24 acquires anchor information of a corresponding anchor block from the anchor picture when the target block to be decoded is a block in the skip/direct mode using anchor information in the target picture to be decoded. Further, the motion compensation unit 24 continuously uses the already acquired anchor information when there are successive blocks in the skip/direct mode and in a case where the anchor information used for a previous block can be considered identical to the anchor information of the target block to be decoded.

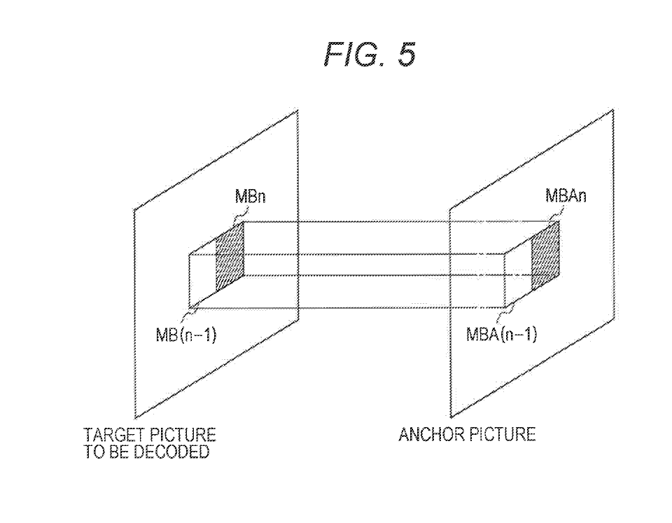

Note that FIG. 5 shows a case where both of the successive blocks require anchor information in the target picture to be decoded. For example, a target block to be decoded MBn in the target picture to be decoded and a previous block MB (n−1) as the previous block are in the prediction mode performing a decoding process using anchor information. Further, in the anchor picture, a block MBAn is an anchor block corresponding to the target block to be decoded MBn and a block MBA (n−1) is an anchor block corresponding to the target block to be decoded MBn.

In FIG. 4(A), when the target block to be decoded is the block MB0, the motion compensation unit 24 acquires the anchor information Anc0 of a corresponding anchor block in the anchor picture because the block MB0 is a block in the skip/direct mode. The motion compensation unit 24 calculates a motion vector of the block MB0 using a motion vector indicated in the acquired anchor information Anc0, performs motion compensation based on the calculated motion vector, and generates prediction image data.

When the target block to be decoded is the block MB1, the motion compensation unit 24 calculates a motion vector in accordance with the prediction mode and generates prediction image data without acquiring the anchor information Anc1 because the block MB1 is not in the skip/direct mode.

When the target block to be decoded is the block MB2, the motion compensation unit 24 acquires the anchor information Anc2 because the block MB2 is in the skip/direct mode and the previous block MB1 as the previous block is not in the skip/direct mode. The motion compensation unit 24 calculates a motion vector of the block MB2 from a motion vector indicated in the acquired anchor information Anc2 and generates prediction image data.

When the target block to be decoded is the block MB3, there are successive blocks of the skip/direct mode because the block MB3 is in the skip/direct mode. Therefore, the motion compensation unit 24 continuously uses the already acquired anchor information Anc2 in a case where the anchor information Anc3 of an anchor block corresponding to the block MB3 can be considered identical to the anchor information Anc2 used for the previous block. The motion compensation unit 24 calculates a motion vector of the block MB3 from a motion vector indicated in the continuously used anchor information Anc2 and generates prediction image data.

Similarly, the blocks MB6 to MB8 are successive blocks in the skip/direct mode and the anchor information Anc6 to Anc8 is information that can be considered identical. Therefore, the motion compensation unit 24 continuously uses the anchor information Anc6 as the information of the blocks MB7 and MB8. The motion compensation unit 24 calculates motion vectors of the blocks MB7 and MB8 as well as of the block MB6 from a motion vector indicated in the continuously used anchor information Anc6 and generates prediction image data.

Further, the blocks MB10 and MB11 are successive blocks in the skip/direct mode. Further, the anchor information Anc10 and the anchor information Anc8 cannot be considered identical. Therefore, the motion compensation unit 24 calculates a motion vector of the block MB10 from a motion vector indicated in the anchor information Anc10 of an anchor block corresponding to the block MB10 and generates prediction image data. Further, the motion compensation unit 24 calculates a motion vector of the block MB11 from a motion vector indicated in the anchor information Anc11 of an anchor block corresponding to the block MB11 and generates prediction image data.

Note that, as shown in FIG. 4(B), in the conventional method, when the target block to be decoded is, for example, the block MB3, the anchor information Anc3 of a corresponding anchor block is required even if the anchor information Anc2 and the anchor information Anc3 can be considered identical. A motion vector of the block MB3 is calculated from a motion vector indicated in the acquired anchor information Anc3, and prediction image data is generated. Also, similarly, when the anchor information Anc6 to Anc8 can be considered identical, the anchor information Anc7 and Anc8 of corresponding anchor blocks is acquired.

As described, above, when an acquisition operation of anchor information is performed using identity of anchor information, it is not necessary to read out anchor information for each block where anchor information of successive blocks can be considered identical, whereby the number of access to the anchor information storage unit 25 can be reduced.

### [2. A Case Where Identity of Anchor Information Is Determined at Decoding]

Next, a case where identity of anchor information is determined at decoding and identical anchor identification information is generated will be described.

The motion compensation unit 24 generates anchor information when a picture likely to be referenced as an anchor picture is decoded. Further, the motion compensation unit 24 determines identity of the generated anchor information and generates identity identification information that indicates a determination result. The identity identification information may just be information that is capable of determining whether the anchor information to be used in the decoding process of the target block to be decoded satisfies an identity condition with the anchor information used for the previous block. For example, as the identity identification information, a flag (hereinafter, “identity flag”) can be used, which indicates whether the anchor information can be considered identical. Further, as another identity identification information, a count value (hereinafter, “identity count value”) may be used, which indicate the number of successive blocks whose anchor information can be considered identical.

### [2-1. A Generation Operation of First Identity Identification Information]

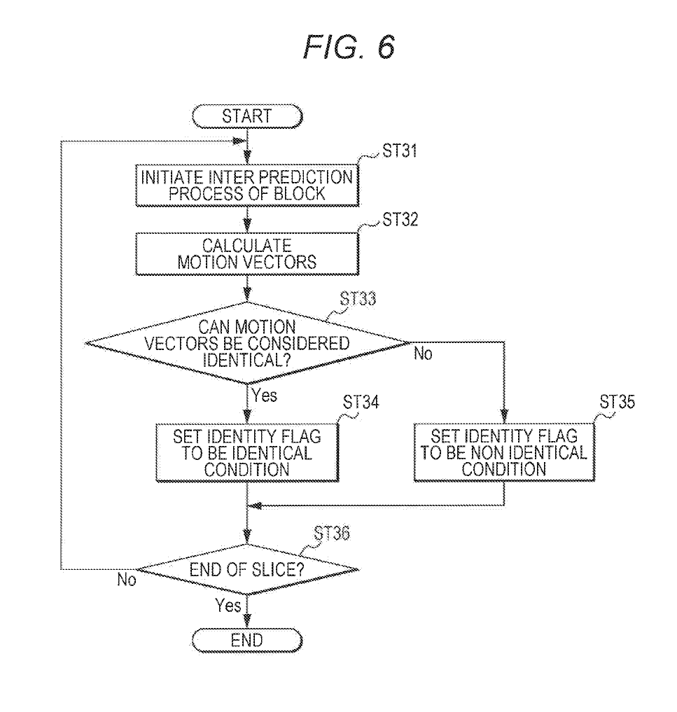

FIG. 6 is a flowchart showing an operation of a case where an identity flag (referred to as “first identity identification information”) is generated as the identity identification information. Note that the operation shown in FIG. 6 is performed with respect to a picture likely to be referenced as an anchor picture.

In step ST31, the motion compensation unit 24 initiates an inter prediction process of a block and proceeds to step ST32.

In step ST32, the motion compensation unit 24 calculates a motion vector. The motion compensation unit 24 calculates, for example, a median of the motion vectors of adjacent blocks as a prediction motion vector. Further, the motion compensation unit 24 adds a difference motion vector indicated in the prediction mode information supplied from the lossless decoding unit 12 to the prediction motion vector to produce a motion vector of the block and proceeds to step ST33. Note that it is not necessary to calculate the motion vector again in order to generate an identity flag by using the motion vector calculated for each block in order to generate the prediction image data in the decoding process of the picture likely to be referenced as the anchor picture.

In step ST33, the motion compensation unit 24 determines whether motion vectors can be considered identical. The motion compensation unit 24 proceeds to step ST34 when the motion vector calculated in step ST32 and a motion vector of a previous block can be considered identical. Meanwhile, the motion compensation unit 24 proceeds to step ST35 when the motion vectors cannot be considered identical. Whether the motion vectors are identical is performed in such a way that a difference between the motion vector of the block and the motion vector of the previous block is compared with a predetermined threshold value, and when the difference of the motion vectors is the threshold value or less, it is determined that the motion vectors can be considered identical, Note that the threshold value will be described below along with a case of determining identity of anchor information at coding.

In step ST34, the motion compensation unit 24 sets the identity flag to be an identical condition. The motion compensation unit 24 sets, for example, an identical flag to be “1” and proceeds to step ST36.

In step ST35, the motion compensation unit 24 sets the identity flag to be a non-identical condition. The motion compensation unit 24 sets, for example, the identical flag to be “0” and proceeds to step ST36.

In step ST36, the motion compensation unit 24 determines whether the process completes until the process of a last block of a slice. The motion compensation unit 24 returns to step ST31 and performs the process of a next block when the process of the last block has not yet completed. Further, when the process of all of the slices of a picture has been completed, the motion compensation unit 24 terminates the generation of the identity flag of the picture.

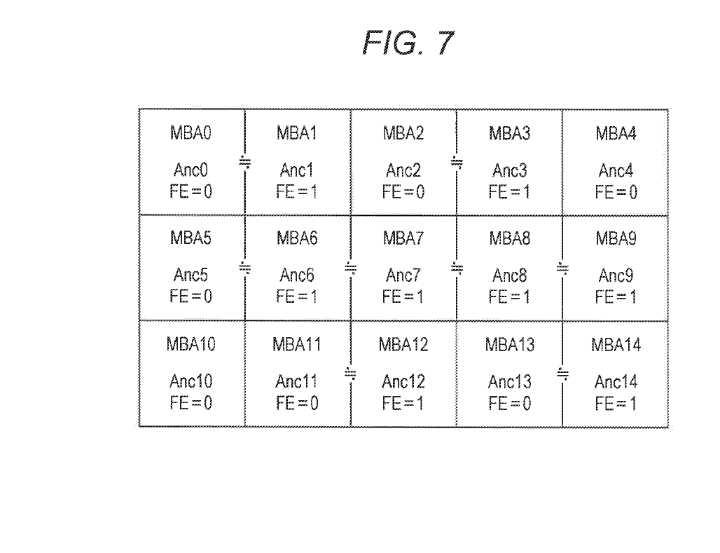

FIG. 7 is a diagram exemplarily showing a generation result of an identity flag. For example, a block MBA0 of a picture has no previous block. Therefore, the motion compensation unit 24 sets an identity flag FE of a block MBA0 to be “0”. Next, the motion compensation unit 24 sets an identity flag FE of a block MBA1 to be “0” when the motion vector of the block MBA1 cannot be considered identical to the motion vector of the previous block MBA0 as the previous block. The motion compensation unit 24 sets an identity flag FE of a block MBA2 to be “0” when the motion vector of the block MBA2 cannot be considered identical to the motion vector of the previous block MBA1. The motion compensation unit 24 sets an identity flag FE of a block MBA3 to be “1” when the motion vector of the block MBA3 can be considered identical to the motion vector of the previous block MBA2. Hereinafter, by performing a process in a similar manner, first identity identification information can be generated. For example, the first identity identification information shown in the case of FIG. 7 is “010100111100101”.

The first identity identification information generated in this way needs to be read out prior to anchor information at decoding. Therefore, the first identity identification information is stored in a memory (for example, a SRAM and the like) provided separately from the anchor information storage unit 25 and capable of fast reading. Also, the first identity identification information has a data amount of 1 bit per block and is a small amount. Therefore, the memory capable of fast reading may have a small capacity.

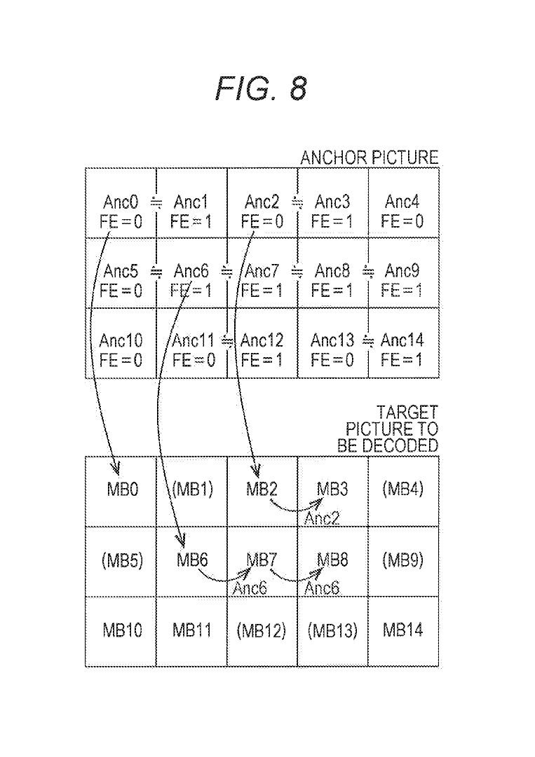

FIG. 8 shows an operation of a case when anchor information is read out using an identity flag. The motion compensation unit 24 reads out anchor information of a corresponding anchor block from the anchor information storage unit 25 when the identity flag FE is “0”. Further, when the identity flag FE is “1”, the motion compensation unit 24 continuously uses anchor information used for a previous block. Therefore, for example, in the process of the block MB3, the anchor information Anc2 read out in the process of the block MB2 is continuously used. Also, in the process of the block MB6, the anchor information Anc6 of a corresponding anchor block is read out from the anchor information storage unit 25 because the previous block MB5 is not in the prediction mode that uses the anchor information. Further, in the processes of the blocks MB7 and MB8, the anchor information Anc6 read out in the process of the block MB6 is continuously is used.

### [2-2. A Generation Operation of Second Identity Identification Information]

Next, a case where an identity count value (referred to as “second identity identification information”) is used as the identity identification information will be described. Note that the identity count value is used, for example, in a case where all of the blocks of a decoding picture is in the skip/direct mode that uses anchor information and an anchor picture is not switched in the middle of a decoding process of the decoding picture. This point will be described below.

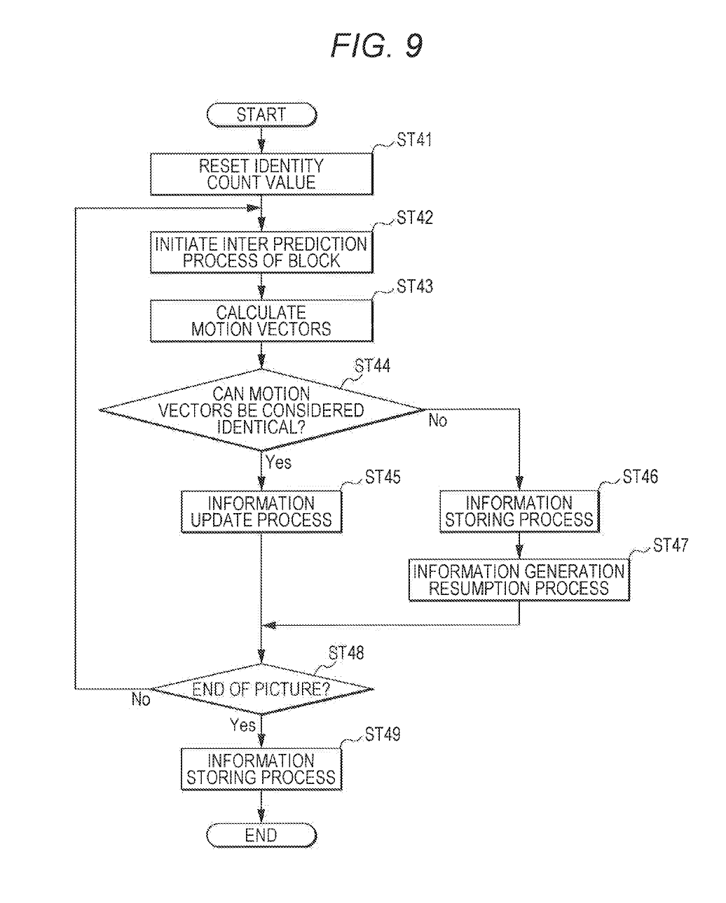

FIG. 9 is a flowchart showing an operation of a case where an identity count value is generated as the identity identification information. Note that the operation shown in FIG. 9 is performed with respect to a picture likely to be referenced as an anchor picture.

In step ST41, the motion compensation unit 24 resets the identity count value and proceeds to step ST42.

In step ST42, the motion compensation unit 24 initiates an inter prediction process of a block and proceeds to step ST43.

In step ST43, the motion compensation unit 24 calculates a motion vector. The motion compensation unit 24 calculates, for example, a median of motion vectors of adjacent blocks as a prediction motion vector. Further, the motion compensation unit 24 adds a difference motion vector indicated in the prediction mode information supplied from the lossless decoding unit 12 to the prediction motion vector to calculate a motion vector of the block and proceeds to step ST44. Note that it is not necessary to calculate the motion vector again in order to generate the identity count value by using the motion vector calculated for each block in order to generate the prediction image data in the decoding process of the picture likely to be referenced as an anchor picture.

In step ST44, the motion compensation unit 24 determines whether motion vectors can be considered identical. The motion compensation unit 24 proceeds to step ST45 when the motion vector of a previous block and the motion vector calculated in step ST43 can be considered identical. Meanwhile, the motion compensation unit 24 proceeds to step ST46 when the motion vectors cannot be considered identical.

In step ST45, the motion compensation unit 24 performs an information update process. The motion compensation unit 24 increments the identity count value that indicates the number of successive blocks whose anchor information can be considered identical. Further, to make the anchor information of the previous block available, the motion compensation, unit 24 holds the previous anchor information and proceeds to step ST48.

In step ST46, the motion compensation unit 24 performs an information storing process. Because the successive blocks whose anchor information cannot be considered identical, the motion compensation unit 24 stores, in the anchor information storage unit 25, information with the anchor information whose identity count value is held and proceeds to step ST47.

In step ST47, the motion compensation unit 24 performs an information generation resumption process. The motion compensation unit 24 resets the identity count value. Also, the motion compensation unit 24 holds anchor information of a block that cannot be considered identical and proceeds to step ST48.

In step ST48, the motion compensation unit 24 determines whether the process has been completed until the process of a last block in the picture. The motion compensation unit 24 returns to step ST42 and performs the process of a next block when the process has not been completed until the process of the last block. Further, the motion compensation unit 24 proceeds to step ST49 when the process of the last block has been completed.

In step ST49, the motion compensation unit 24 performs an information storing process. Because the motion compensation unit 24 has determined identity of the last block of the picture, the motion compensation unit 24 stores information with the anchor information whose identity count value is held in the anchor information storage unit 25 and terminates the generation of the identity count value of the picture.

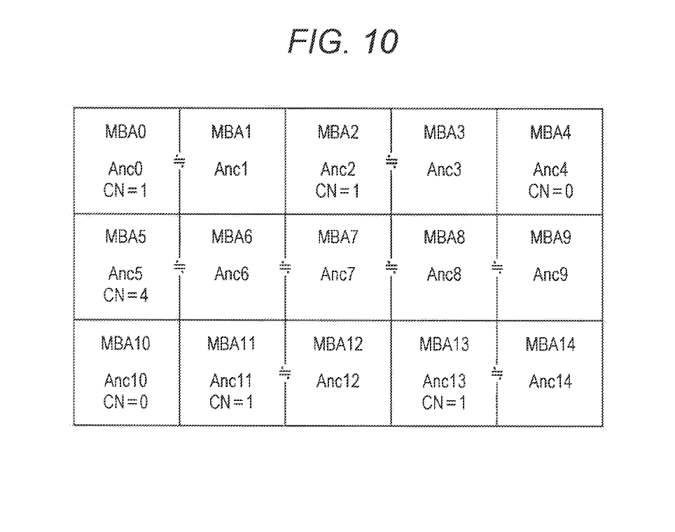

FIG. 10 is a diagram exemplarily showing a generation result of an identity count value. For example, because the anchor information Anc0 of the block MBA0 of the picture and the anchor information Anc1 of the next block MBA1 can be considered identical, the anchor information Anc0 is held. Also, an identity count value CN is incremented to be CN=1. Next, because the held anchor information Anc0 and the anchor information Anc2 of the next block MBA2 cannot be considered identical, the identity count value CN=1 is stored with the held anchor information Anc0 in the anchor information storage unit 25. Further, the count value is reset and the identity count value CN is set to be CN=0. Further, the anchor information Anc2 is held.

Next, because the held anchor information Anc2 and the anchor information Anc3 of the block MBA3 can be considered identical, the anchor information Anc2 is held. Further, the identity count value CN is incremented to be CN=1. Next, because the held anchor information Anc2 and the anchor information Anc4 of the next block MBA4 cannot be considered identical, the identity count value CN=1 is stored with the held anchor information Anc2. Further, the anchor information Anc4 is held and the count value is reset and the identity count value CN is set to be CN=0.

Because the held anchor information Anc4 and the anchor information Anc5 of the next block MBA5 cannot be considered identical, the held anchor information Anc4 is stored with the identity count value CN=0 in the anchor information storage unit 25. Further, the count value is reset and the identity count value CN is set to be CN=0. Also, the anchor information Anc5 is held.

Next, because the held anchor information Anc5 and the anchor information Anc6 of the block MBA6 cannot be considered identical, the anchor information Anc5 is held. Also, the identity count value CN is incremented to be CN=1. Next, because the held anchor information Anc5 and the anchor information Anc7 of the block MBA7 can be considered identical, the anchor information Anc5 is held. Also, the identity count value CN is incremented to be CN=2. Because the held anchor information Anc5 and the anchor information Anc8 of the block MBA8 can be considered identical, the anchor information Anc5 is held. Also, the identity count value CN is incremented to be CN=3. Next, because the held anchor information Anc5 and the anchor information Anc9 of the block MBA9 can be considered identical, the anchor information Anc5 is held. Also, the identity count value CN is incremented to be CN=4. Next, because the held anchor information Anc5 and the anchor information Anc10 of the block MBA10 cannot be considered identical, the held anchor information Anc5 is stored with the identity count value CN=4 in the anchor information storage unit 25. Further, the count value is reset and the identity count, value CN is set to be CN=0. Further, the anchor information Anc10 is held.

Hereinafter, by performing a process in a similar manner, the anchor information Anc0 and the identity count value CN=1, the anchor information Anc2 and the identity count value CN=1, and the anchor information Anc4 and the identity count value CN=0 are stored. Also, the anchor information Anc5 and the identity count value CN=4, the anchor information Anc10 and the identity count value CN=0, and the anchor information Anc11 and the identity count value CN=1 are stored in the anchor information storage unit 25. Further, the anchor information Anc13 and the identity count value CN=1 are stored in the anchor information storage unit 25.

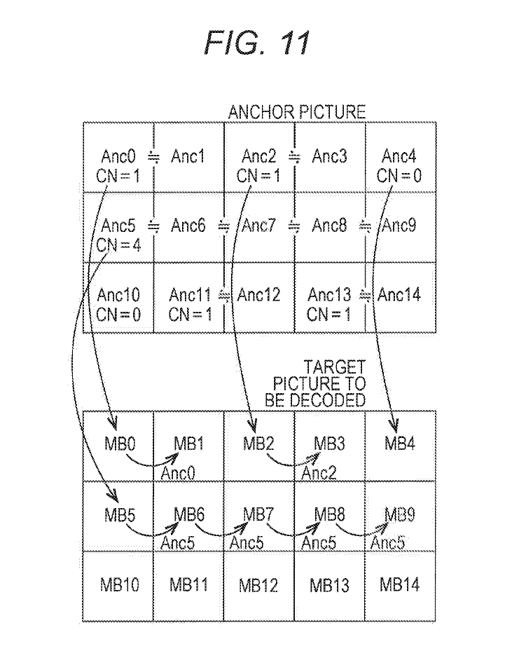

FIG. 11 shows a case where anchor information is read out using an identity count value. The motion compensation unit 24 reads out anchor information and an identity count value corresponding to the first block MB0. Here, because the identity count value of the first anchor information Anc0 is CN=1, it can be determined that the anchor information Anc0 can be used with respect to the block MB1 and the anchor information Anc0 cannot be used with respect to the block MB2. Therefore, the decoding process of the block MB0 is performed using the anchor information. Anc0, and the decoding process of the block MB1 is performed continuously using the anchor information Anc0.

In the block MB2, because the anchor information Anc0 cannot be used, anchor information and an identity count value corresponding to the block MB2 is read out. Here, because the identity count value of the anchor information Anc2 is CN=1, it can be determined that the anchor information Anc2 can be used with respect to the block MR3 and the anchor information Anc0 cannot be used with respect to the block MB4. Therefore, the decoding process of the block MB2 is performed using the anchor information Anc2, and the decoding process of the block MB3 is performed continuously using the anchor information Anc2.

Because the anchor information Anc2 cannot be used for the block MB4, anchor information and an identity count value corresponding to the block MB4 are read out. Here, because the identity count value of the anchor information Anc4 is CN=0, it can be determined that the anchor information Anc4 cannot be used with respect to the block MB5. Therefore, the decoding process of the block MB4 is performed using the anchor information Anc4.

Because the anchor information Anc4 cannot be used for the block MB5, anchor information and an identity count value corresponding to the block MB5 is read out. Here, because the identity count value of the anchor information Anc5 is CN=4, it can be determined that the anchor information Anc5 can be used with respect to the blocks MB6 to MB9 and the anchor information Anc5 cannot be used with respect to the block MB10. Therefore, the decoding process of the block MB5 is performed using the anchor information Anc5, and the decoding processes of the blocks MB6 to MB9 are performed continuously using the anchor information Anc5.

In this way, it is not necessary to read out the anchor information for each block by reading out the anchor information, and the identity count value and continuously using the anchor information based on the identity count value. It is also not necessary for the anchor information storage unit 25 to store the anchor information for each block. Therefore, it becomes possible to reduce the capacity of the anchor information storage unit 25.

Note that, when the identity count value is used as the identity identification information, the identity count value and the held anchor information are stored in the anchor information storage unit 25. Therefore, if, in the target picture to be decoded, the block that does not use anchor information is not taken into account, the order of target blocks to be decoded and the order of blocks based on the identity count value cannot correspond to each other. Therefore, if all of the blocks of the target pictures to be decoded use anchor information, the order of target blocks to be decoded and the order of blocks based on the identity count value correspond to each other, whereby the decoding process can be easily performed. Also, in a case where the anchor picture is switched in the middle of a picture, there is no guarantee to read out anchor information for the switched block. Therefore, in the case where the anchor picture is not switched in the middle of a picture, the identity count value can be used.

### [3. A Case Where Identity of Anchor Information Is Determined at Coding]

As described above, the identity identification information may just be information capable of determining whether the anchor information to be used at the decoding process of the target block to be decoded satisfies the identity condition with the anchor information used for the previous block, and the identity identification information can be generated at coding as well as at decoding. When the identity identification information is generated at coding, the generated identity identification information is included in a coded stream. An image decoding apparatus extracts the identity identification information from the coded stream, and acquires the anchor information or continuously uses the anchor information of the previous block based on the extracted identity identification information. Next, identity of anchor information is determined at coding and identical anchor identification information is generated will be described.

### [3-1. A Configuration of an Image Coding Apparatus]

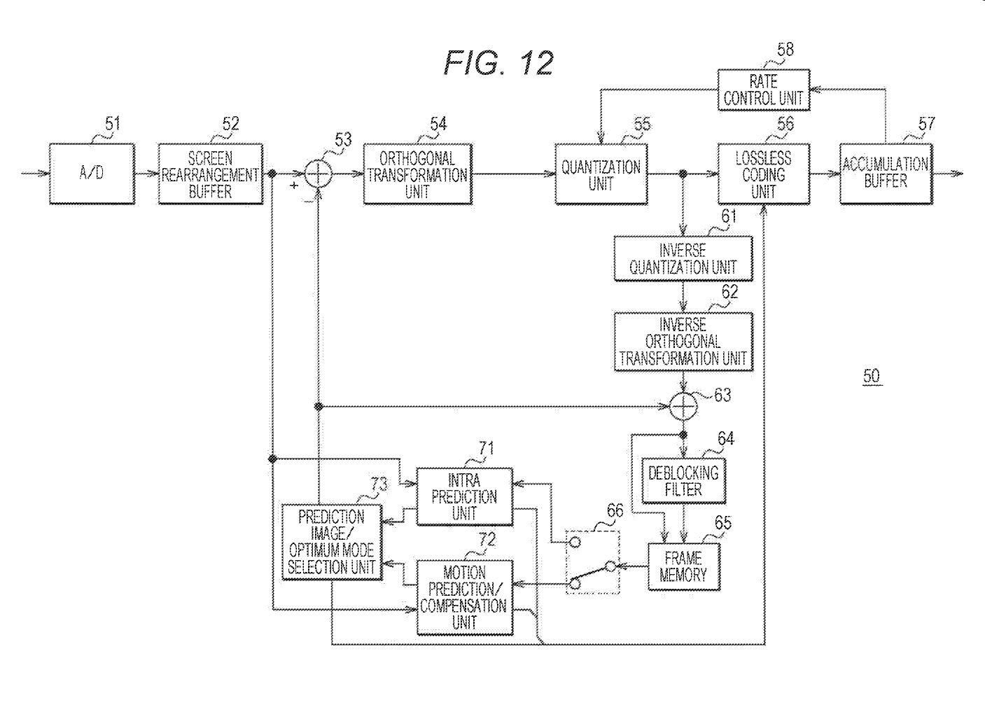

FIG. 12 shows a configuration of an image coding apparatus 50. The image coding apparatus 50 is an information processing apparatus that performs a coding process and includes an analog/digital conversion unit (A/D conversion unit) 51, a screen rearrangement buffer 52, a subtraction unit 53, an orthogonal transformation unit 54, a quantization unit 55, a lossless coding unit 56, an accumulation buffer 57, and a rate control unit 58. Further, the image coding apparatus 50 includes an inverse quantization unit 61, an inverse orthogonal transformation unit 62, an adding unit 63, a deblocking filter 64, a frame memory 65, a selector 66, an intra prediction unit 71, a motion prediction/compensation unit 72, and a prediction image/optimum mode selection unit 73.

The A/D conversion unit 51 converts an analog image signal into digital image data and outputs the digital image data to the screen rearrangement buffer 52.

The screen rearrangement buffer 52 performs frame rearrangement with respect to the image data output from the A/D conversion unit 51. The screen rearrangement buffer 52 performs the frame rearrangement in accordance with a GOP (group of pictures) structure according to the coding process and outputs the rearranged image data to the subtraction unit 53, the intra prediction unit 71, and the motion prediction/compensation unit 72.

The image data output from the screen rearrangement buffer 52 and the prediction image data selected by the prediction image/optimum mode selection unit 73 described below are supplied to the subtraction unit 53. The subtraction unit 53 calculates prediction error data that is a difference between the image data output from the screen rearrangement buffer 52 and the prediction image data supplied from the prediction image/optimum mode selection unit 73 and outputs the prediction error data to the orthogonal transformation unit 54.

The orthogonal transformation unit 54 performs an orthogonal transformation process such as discrete cosine transform (DCT) and Karhunen/Loeve transform with respect to the prediction error data output from the subtraction unit 53. The orthogonal transformation unit 54 outputs transformation coefficient data obtained by the orthogonal transformation process to the quantization unit 55.

The transformation coefficient data output from the orthogonal transformation unit 54 and a rate control signal from the rate control unit 58 described below are supplied to the quantization unit 55. The quantization unit 55 performs quantization of the transformation coefficient data and outputs the quantization data to the lossless coding unit 56 and the inverse quantization unit 61. Also, the quantization unit 55 switches a quantization parameter (quantization scale) based on the rate control signal from the rate control unit 58 to change a bit rate of the quantization data.

The quantization data output from the quantization unit 55 and prediction mode information from the intra prediction unit 71, the motion prediction/compensation unit 72, and the prediction image/optimum mode selection unit 73 are supplied to the lossless coding unit 56. Note that the prediction mode information includes a prediction mode (optimum prediction mode) in an intra prediction or in an inter prediction, a motion vector of a target block to be coded in the inter prediction, and reference picture information. The lossless coding unit 56 performs a lossless coding process by means of variable length coding or arithmetic coding with respect to the quantization data, for example, generates a coded stream, and outputs the coded stream to the accumulation buffer 57. Also, the lossless coding unit 56 performs lossless coding of the prediction mode information and adds the information to header information of the coded stream. Further, when identity identification information is generated at image coding, the lossless coding unit 56 includes the identity identification information generated in the motion prediction/compensation unit 72 to the coded stream. Further, the lossless coding unit 56 reduces a data amount of the prediction mode information by including a difference motion vector to the prediction mode information in place of the motion vector of the target block to be coded calculated in the motion prediction/compensation unit 72. In this case, the lossless coding unit 56 calculates a median from the already calculated motion vectors in relation to a block adjacent to the target block to be coded, for example, to produce a prediction motion vector. The lossless coding unit 56 calculates a difference between the prediction motion vector and the motion vector of the target block to be coded calculated in the motion prediction/compensation unit 72 to produce a difference motion vector.

The accumulation buffer 57 accumulates the coded stream from the lossless coding unit 56. Further, the accumulation buffer 57 outputs the accumulated coded stream with a transmission speed in accordance with a transmission line.

The rate control unit 58 monitors a free space of the accumulation buffer 57, generates a rate control signal in accordance with the free space, and outputs the signal to the quantization unit 55. The rate control unit 58 acquires information indicating the free space from the accumulation buffer 57, for example. The rate control unit 58 decreases a bit rate of the quantization data by the rate control signal when the free space is small. Meanwhile, the rate control unit 58 increases the bit rate of the quantization data by the rate control signal when the free space of the accumulation buffer 57 is sufficiently large.

The inverse quantization unit 61 performs an inverse quantization process of the quantization data supplied from the quantization unit 55. The inverse quantisation unit 61 outputs, to the inverse orthogonal transformation unit 62, transformation coefficient data obtained by performing the inverse quantization process.

The inverse orthogonal transformation unit 62 outputs, to the adding unit 63, data obtained by performing an inverse orthogonal transformation process of the transformation coefficient data supplied from the inverse quantization unit 61.

The adding unit 63 adds the data supplied from the inverse orthogonal transformation unit 62 and the prediction image data supplied from the prediction image/optimum mode selection unit 73 to generate decoded image data, and outputs the generated data to the deblocking filter 64 and the frame memory 65.

The deblocking filter 64 performs a filtering process for reducing block distortion caused at decoding of an image. The deblocking filter 64 performs the filtering process to remove block distortion of the decoded image data supplied form the adding unit 63 and outputs the decoded image data after the filtering process to the frame memory 65.

The frame memory 65 holds the decoded image data supplied from the adding unit 63 and the decoded image data after the filtering process supplied from the deblocking filter 64.

The selector 66 supplies, to the intra prediction unit 71, the decoded image data before the filtering process read out from the frame memory 65 in order to perform an intra prediction. Also, the selector 66 supplies, to the motion prediction/compensation unit 72, the decoded image data after the filtering process read out from the frame memory 65 in order to perform an inter prediction.

The intra prediction unit 71 performs an intra prediction process in all of the candidate intra prediction modes using the image data of the target image to be coded output from the screen rearrangement buffer 52 and the decoded image data before the filtering process read out from the frame memory 65. Further, the intra prediction unit 71 calculates a cost function value with respect to each intra prediction mode and selects, as an optimum intra prediction mode, an intra prediction mode that minimizes the calculated cost function value, that is, an intra prediction mode that optimizes the coding efficiency. The intra prediction unit 71 outputs, to the prediction image/optimum mode selection unit 73, the prediction image data generated in the optimum intra prediction mode, the prediction mode information regarding the optimum intra prediction mode, and the cost function value at the optimum intra prediction mode. Also, the intra prediction unit 71 outputs, to the lossless coding unit. 56, information indicating the intra prediction mode in the intra prediction process in each intra prediction mode in order to obtain a generated code amount to be used to calculate the cost function value.

The motion prediction/compensation unit 72 performs an inter prediction process in all of the candidate inter prediction mode using the image data of the target image to be coded output from the screen rearrangement buffer 52 and the decoded image data after the filtering process output from the frame memory 65. Further, the motion prediction/compensation unit 72 calculates a cost function value with respect to each inter prediction mode and selects, as an optimum intra prediction mode, an inter prediction mode that minimizes the calculated cost function value, that is, an inter prediction mode that optimizes the coding efficiency. The motion prediction/compensation unit 72 outputs, to the prediction image/optimum mode selection, unit 73, the prediction image data generated in the optimum inter prediction mode, the prediction mode information regarding the optimum inter prediction mode, and the cost function value in the optimum inter prediction mode. Also, the motion prediction/compensation unit 72 outputs, to the lossless coding unit 56, information regarding the inter prediction mode in the inter prediction process in each inter prediction mode in order to obtain a generated code amount to be used to calculate the cost function value. Further, when identity identification information is generated at image coding, the motion prediction/compensation unit 72 generates the identity identification information and outputs the generated information to the prediction image/optimum mode selection unit 73 or the lossless coding unit 56.

The prediction image/optimum mode selection unit 73 compares the cost function values supplied from the intra prediction unit 71 and from the motion prediction/compensation unit 72 in a unit of a block and selects a smaller cost function value as an optimum mode that maximizes the coding efficiency. Also, the prediction image/optimum mode selection unit 73 outputs the prediction image data generated in the optimum mode to the subtraction unit 53 and the adding unit 63. Further, the prediction image/optimum mode selection unit 73 outputs prediction mode information of the optimum mode to the lossless coding unit 56. Also, when the identity identification information is supplied from the motion prediction/compensation unit 72, the prediction image/optimum mode selection unit 73 outputs identity identification information to the lossless coding unit 56 in a case where the optimum inter prediction mode is selected as the optimum mode. Note that the prediction image/optimum mode selection unit 73 performs the intra prediction or the inter prediction in a unit of a picture or of a slice.

### [3-2. A Configuration of a Motion Prediction/Compensation Unit]

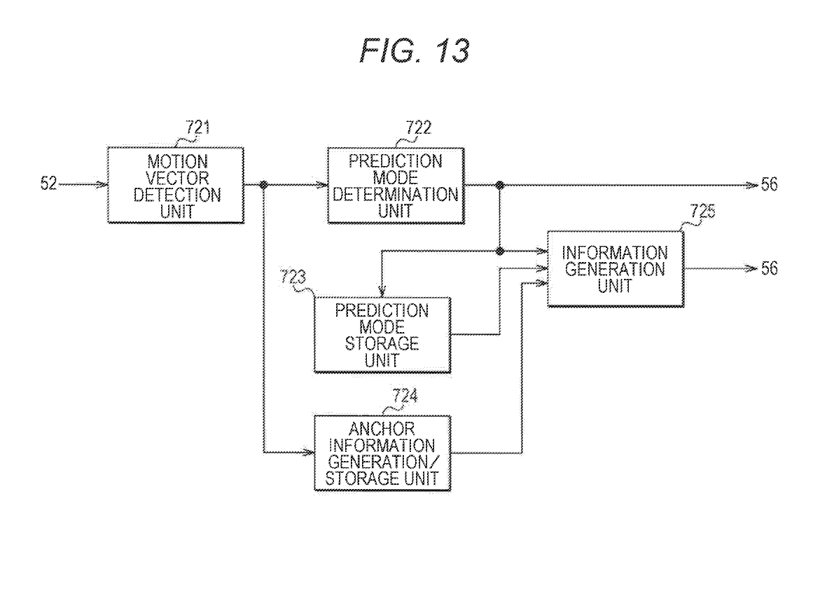

FIG. 13 exemplarily shows a configuration part regarding generation of identity identification information in the motion prediction/compensation unit 72. The motion prediction/compensation unit 72 includes a motion vector detection unit 721, a prediction mode determination unit 722, a prediction mode storage unit 723, an anchor information generation/storage unit 724, and an information generation unit 725.

The motion vector detection unit 721 detects a motion vector using image data of a block of a target image to be coded read out from the screen rearrangement buffer 52 and the decoded image data after the filtering process read out from the frame memory 65. The motion vector detection unit 721 supplies the detected motion vector to the prediction mode determination unit 722 and the anchor information generation/storage unit 724.

The prediction mode determination unit 722 generates prediction image data by applying a motion compensation process to the decoded image data based on the supplied motion vector. Also, the prediction mode determination unit 722 calculates a cost function value when the generated prediction image data is used. Also, the prediction mode determination unit 722 generates the prediction image data in each prediction mode and calculates the cost function value in each prediction mode. Further, the prediction mode determination unit 722 determines a prediction mode that minimizes the cost function value as an optimum inter prediction mode. The prediction mode determination unit 722 supplies prediction mode information indicating the determined optimum inter prediction mode to the information generation unit 725, the prediction image/optimum mode selection unit 73, and the like.

The prediction mode storage unit 723 stores the prediction mode determined in a unit of a picture or of a slice. Further, the prediction mode storage unit 723 supplies the stored prediction mode to the information generation unit 725.

The anchor information generation/storage unit 724 generates anchor information using the motion vector detected in the motion vector detection unit 721 and the like. Further, the anchor information generation/storage unit 724 stores the generated anchor information.

The information generation unit 725 generates identity identification information based on the optimum inter prediction mode determined in the prediction mode determination unit 722, the prediction mode stored in the prediction mode storage unit 723, and the anchor information stored in the anchor information generation/storage unit 724. That is, the information generation unit 725 determines whether the optimum inter prediction mode determined in the prediction mode determination unit 722 is a prediction mode that uses anchor information. The information generation unit 725 determines the prediction mode of a previous block stored in the prediction mode storage unit 723 when the optimum inter prediction mode is a prediction mode using anchor information. The information generation unit 725 determines whether the anchor information of the block stored in the anchor information generation/storage unit 724 can be considered identical to the anchor information used for a previous block when the prediction mode of the previous block is a prediction mode using anchor information. The information generation unit 725 determines that the identity identification information can be considered identical to the anchor information of the previous block when the anchor information of the block can be considered identical to the anchor information used for the previous block. Otherwise, the information generation unit 725 determines that the identity identification information is information that cannot be considered identical to the anchor information of the previous block. In this way, the information generation unit 725 generates the identity identification information and supplies the generated information to the lossless coding unit 56 or to the lossless coding unit 56 via the prediction image/optimum mode selection unit 73.

### [3-3. An Operation of an Image Coding Apparatus]

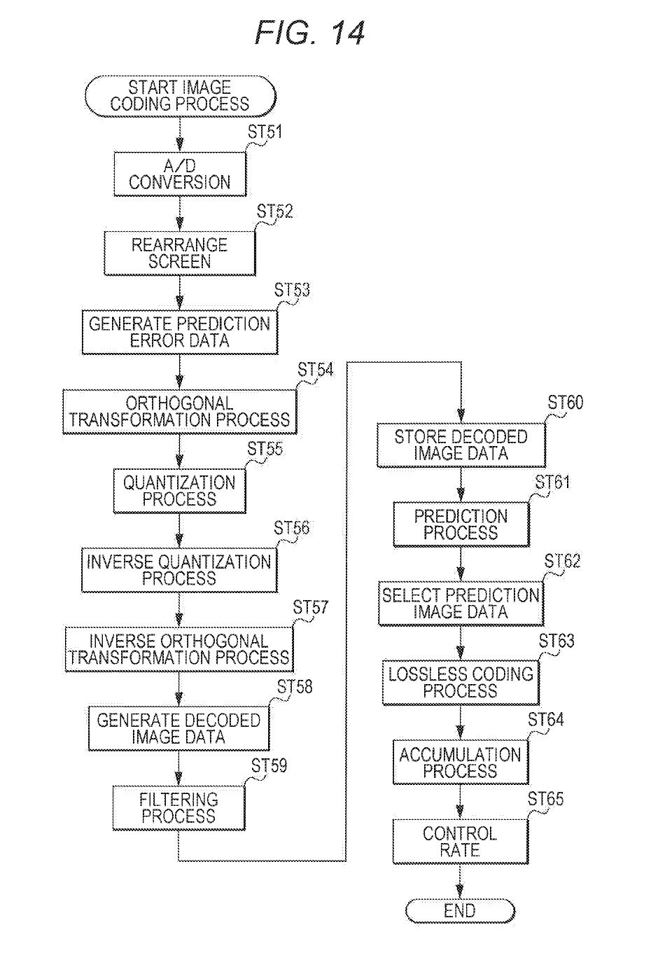

Next, an image coding process operation will be described. FIG. 14 is a flowchart showing an image coding process operation. In step ST51, the A/D conversion unit 51 performs A/D conversion of an input image signal.

In step ST52, the screen rearrangement buffer 52 performs image rearrangement. The screen rearrangement buffer 52 stores the image data supplied from the A/D conversion unit 51 and rearranges the order of display of each picture to the order of coding of each picture.

In step ST53, the subtraction unit 53 generates prediction error data. The subtraction unit 53 calculates a difference between the image data of an image rearranged in step ST52 and the prediction image data selected in the prediction image/optimum mode selection unit 73 to generate prediction error data. The prediction error data has a smaller data amount than the original image data. Therefore, the data amount can be compressed, compared with a case of coding the image as is.

In step ST54, the orthogonal transformation unit 54 performs an orthogonal transformation process. The orthogonal transformation unit 54 performs orthogonal transformation of the prediction error data supplied from the subtraction unit 53. To be more specific, the orthogonal transformation unit 54 performs the orthogonal transformation with respect to the prediction error data such as discrete cosine transform and Karhunen/Loeve transform and outputs transformation coefficient data.

In step ST55, the quantization unit 55 performs a quantization process. The quantization unit 55 quantizes the transformation coefficient data. In quantizing, a rate control is performed as described in step ST65 below,

In step ST56, the inverse quantization unit 61 performs an inverse quantization process. The inverse quantization unit 61 inversely quantizes the quantization transformation coefficient data quantized by the quantization unit 55 with a characteristic corresponding to a characteristic of the quantization unit 55.

In step ST57, the inverse orthogonal transformation unit 62 performs an inverse orthogonal transformation process. The inverse orthogonal transformation unit 62 performs inverse orthogonal transformation of the transformation coefficient data inversely quantized by the inverse quantization unit 61 with a characteristic corresponding to a characteristic of the orthogonal transformation unit 54.

In step ST58, the adding unit 63 generates decoded image data. The adding unit 63 adds the prediction image data supplied from the prediction image/optimum mode selection unit 73, and the prediction image data and the data of the target block to be decoded after the inverse orthogonal transformation to generate decoded image data.

In step ST59, the deblocking filter 64 performs a filtering process. The deblocking filter 64 filters the decoded image data output from the adding unit 63 to remove block distortion.

In step ST60, the frame memory 65 stores decoded image data. The frame memory 65 stores the decoded image data before the filtering process and the decoded image data after the filtering process.

In step ST61, the intra prediction unit 71 and the motion prediction/compensation unit 72 respectively perform prediction processes. That is, the intra prediction unit 71 performs an intra prediction process in an intra prediction mode, and the motion prediction/compensation unit 72 performs a motion prediction/compensation process in an inter prediction mode. In the prediction processes, the prediction process is performed in each of all candidate prediction modes, and each cost function value of each prediction mode is calculated. Then, an optimum intra prediction mode and an optimum inter prediction mode are selected based on the calculated cost function value, and an prediction image generated in the selected prediction mode and its cost function and prediction mode information are supplied to the prediction image/optimum mode selection unit 73.

In step ST62, the prediction image/optimum, mode selection unit 73 selects prediction image data. The prediction image/optimum mode selection unit 73 determines an optimum mode that optimizes the coding efficiency based on each cost function value output from the intra prediction unit 71 and the motion prediction/compensation unit 72. Further, the prediction image/optimum mode selection unit 73 selects prediction image data of the determined optimum mode and supplies the selected data to the subtraction unit 53 and the adding unit 63. This prediction image is used for the calculation in step ST58 described above. Note that prediction mode information corresponding to the selected prediction image data is output to the lossless coding unit 56.

In step ST63, the lossless coding unit 56 performs a lossless coding process, The lossless coding unit 56 performs lossless coding of the quantisation data output from the quantization unit 55. That is, the lossless coding unit 56 performs lossless coding of the quantization data such as variable length coding and arithmetic coding and compresses the processed data. At this time, the prediction mode information (including the prediction mode, the difference motion vector, the reference picture information and the like) input to the lossless coding unit 56 and the like are also subjected to the lossless coding in step ST62 described above. Further, lossless coded data of the prediction mode information is added to header information of a coded stream generated by performing the lossless coding of the quantization data. Further, when the identity identification information is generated at image coding, the lossless coding unit 56 includes the identity identification information generated in the motion prediction/compensation unit 72 to the coded stream.

In step ST64, the accumulation buffer 57 performs an accumulation process. The accumulation buffer 57 accumulates the coded stream output from the lossless coding unit 56. This coded stream accumulated in the accumulation buffer 57 is properly read out and transmitted to the decoding side via a transmission line.

In step ST65, the rate control unit 58 performs a rate control. The rate control unit 58 controls a rate of a quantisation operation by the quantization unit 55 not to generate an overflow or an underflow in the accumulation buffer 57 when the coded stream is accumulated in the accumulation buffer 57.

Next, a prediction process in step ST61 in FIG. 14 will be described. The intra prediction unit 71 performs an intra prediction process. The intra prediction unit 71 performs intra prediction of an image of a current block in all of the candidate intra prediction modes. Note that, as image data of a decoded image referenced in the intra prediction, the decoded image data stored in the frame memory 65 without being subjected to the filtering process in the deblocking filter 64 is used. In the intra prediction process, the intra prediction is performed in all of the candidate intra prediction modes, and a cost function value is calculated with respect to all of the candidate intra prediction modes. Then, an intra prediction mode that optimizes the coding efficiency is selected from among all of the intra prediction modes based on the calculated cost function values.

The cost function values are calculated based on a method of either a high complexity mode or a low complexity mode as defined by JM (joint model) that is reference software in H.264/AVC method.

That is, the high complexity mode provisionally performs the processes until the lossless coding process with respect to all of the candidate prediction modes and calculates a cost function value expressed in the following formula (1) with respect to each of the prediction modes.

Cost (Mode Ω)=D+λ/R (1)

“Ω” represents a whole set of candidate prediction modes for coding of the block or the macroblock. “D” represents difference energy (distortion) between a decoded image coded in the prediction mode and an input image. “R” represents a generated code amount including the orthogonal transformation coefficient, the prediction mode information, and the like, and “λ” represents a Lagrange multiplier given as a function of a quantization parameter QP.

That is, to code in the high complexity mode, it is necessary to perform a provisional encoding process once in all of the candidate prediction modes in order to calculate the above-described parameters D an R, and therefore, a larger amount of computation is required.

On the other hand, in the low complexity mode, generation of a prediction image and calculation of information, until a header bit such as motion vector information and prediction mode information are performed with respect to all of the candidate prediction modes, and a cost function value expressed by the following formula (2) is calculated with respect to each of the prediction modes.

Cost (Mode Ω)=D+QPtoQuant (QP)/Header_Bit (2)

“Ω” represents a whole set of candidate prediction modes for coding the block or the macroblock. “D” represents difference energy (distortion) between a decoded image decoded in the prediction mode and an input image. “Header_Bit” represents a header bit with respect to the prediction mode, and “QPtoQuant” represents a function given as a function of a quantization parameter QP.

That is, in the low complexity mode, although it is necessary to perform the prediction process with respect to each of the prediction modes, it is not necessary to process decoded image. Therefore, a lower amount of computation than that of the high complexity mode is possible.

The motion prediction/compensation unit 72 performs an inter prediction process. The motion prediction/compensation unit 72 uses the decoded image data after the filtering process stored in the frame memory 65 and performs the inter prediction process in all of the candidate inter prediction modes. The motion prediction/compensation unit 72 performs the prediction process in all of the candidate inter prediction modes and calculates a cost function value with respect to all of the candidate inter prediction modes. Then, an inter prediction mode that optimizes the coding efficiency is selected from among all of the inter prediction modes based on the calculated cost function values.

### [3-4. A Generation Operation of Identity Identification Information]

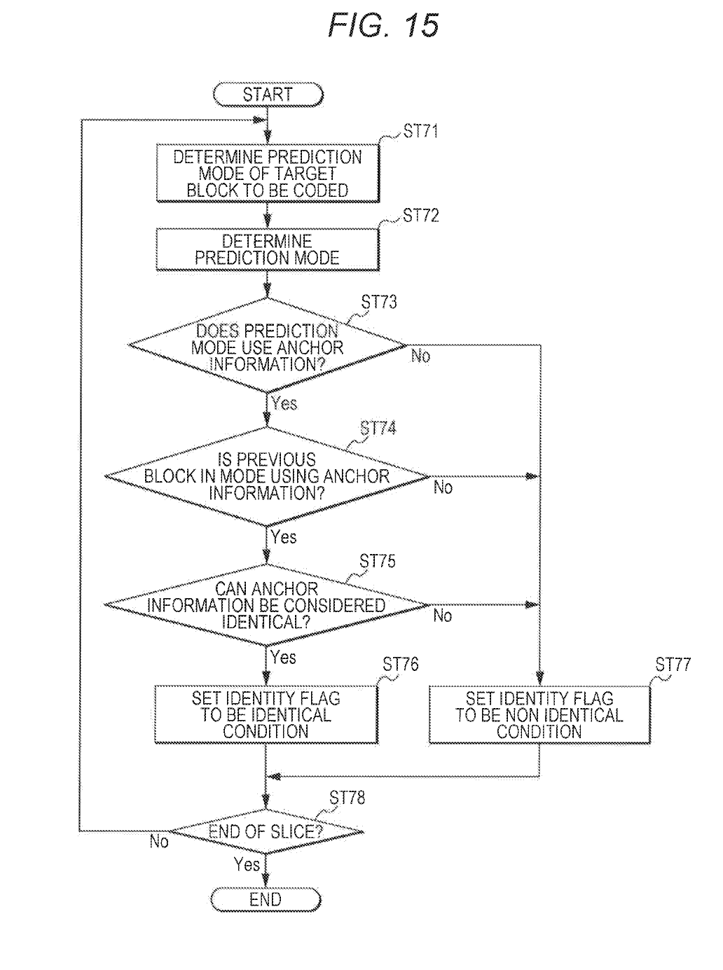

FIG. 15 is a flowchart showing an operation of a case where an identity flag is generated as identity identification information.

In step ST71, the motion prediction/compensation unit 72 determines a prediction mode of a target block to be coded. The motion prediction/compensation unit 72 performs, as described above, a prediction process in all of the candidate inter prediction modes and calculates a cost function value with respect to all of the candidate prediction modes.

In step ST72, the motion prediction/compensation unit 72 determines a prediction mode. The motion prediction/compensation unit 72 determines a prediction mode that optimizes the coding efficiency, that is, a prediction mode that minimizes the cost function value based on the cost function values calculated in step ST71 and proceeds to step ST73.

In step ST73, the motion prediction/compensation unit 72 determines whether it is a prediction mode using anchor information. The motion prediction/compensation unit 72 proceeds to step ST74 when the target block to be coded is in a prediction mode using anchor information, that is, in the skip/direct mode, whilst proceeds to step ST77 when the target block to be coded is in other modes.

In step ST74, the motion prediction/compensation unit 72 determines whether a previous block is a block using anchor information. The motion prediction/compensation unit 72 proceeds to step ST75 when the previous block is a block subjected to a decoding process using anchor information. Meanwhile, the motion prediction/compensation unit 72 proceeds to step ST77 when the previous block is not a block subjected to the decoding process using anchor information.

In step ST75, the motion prediction/compensation unit 72 determines whether the anchor information can be considered identical. The motion prediction/compensation unit 72 proceeds to step ST76 when the anchor information to be used in the coding process of the block and the anchor information used for the previous block can be considered identical. Meanwhile, the motion prediction/compensation unit 72 proceeds to step ST77 when the anchor information to be used in the coding process of the block and the anchor information used for the previous block cannot be considered identical.

In step ST76, the motion prediction/compensation unit 72 sets the identity flag to be an identical condition. The motion prediction/compensation unit 72 sets an identical flag to be “1”, for example, and proceeds to step ST78.

In step ST77, the motion prediction/compensation unit 72 sets the identity flag to be a non-identical condition. The motion prediction/compensation unit 72 sets the identical flag to be “0”, for example, and proceeds to step ST78.

In step ST78, the motion prediction/compensation unit 72 determines whether the end of a slice. The motion prediction/compensation unit 72 returns to step ST71 when a block is not the last one of the slice and performs the process of a next block. Also, the motion prediction/compensation unit 72 terminates the generation of the identity flag of a picture when the process of all of the slices of the target picture to be coded is completed.

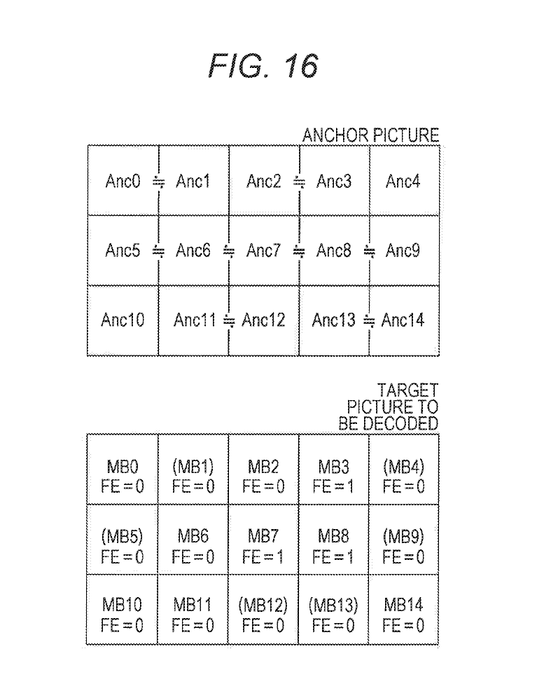

FIG. 16 is a diagram exemplarily showing a generation result of an identity flag. For example, the block MB0 of the target picture to be coded has no previous block. Therefore, the motion prediction/compensation unit 72 sets an identity flag FE of the block MB0 to be “0”.

The motion prediction/compensation unit 72 sets an identity flag FE of the block MB1 to be “0” because the next block MB1 is not in a mode using anchor information.

The motion prediction/compensation unit 72 sets an identity flag FE of the block MB2 to be “0” because the block MB2 is in a mode using anchor information and the previous block MB1 is not in a mode using anchor information.

The motion prediction/compensation unit 72 can consider the block MB3 and the previous block MB2 are in a mode using anchor information, and the anchor information Anc3 used for the block MB3 and the anchor information Anc2 used for the previous block MB2 are identical to each other. Therefore, the motion prediction/compensation unit 72 sets an identity flag FE of the block MB3 to be “1”. Hereinafter, by performing a process in a similar manner, the identity flag FE can be generated as shown in FIG. 16.

Also, by reading out or continuously using the anchor information using the identity flag shown in FIG. 16, a similar operation to FIG. 8 is realized.

In this way, the identity identification information is generated in the coding process and the decoding process is performed using the generated identity identification information as described above, whereby the decoding process can be performed without reading out anchor information for each target block to be decoded.

### [4. Comparison of Identity of Anchor Information Generated at Decoding and at Coding]

### [4-1. Comparison of Generation Operations of Identity Identification Information]

Table 1 shows a comparison result between a case where identity identification information is generated in an image coding apparatus and a case where identity identification information is generated in an image decoding apparatus.

TABLE 1

| | | At decoding | |
|---|---|---|---|
| | At coding | | Identity |
| | Identity flag | Identity flag | count value |
| Storing in | None | Present | None |
| small | | | |
| capacity | | | |
| memory | | | |
| Storing in | Storing of | Storing of | Storing of |
| anchor | all blocks | all blocks | part of |
| information | | | blocks |
| storing | | | |
| memory | | | |
| Effect on | Bit addition | No bit | No bit |
| stream | | addition | addition |
| Restriction | None | None | Present |
| to anchor | | | |
| picture | | | |

In storing in a small capacity memory, when identity of anchor information is determined and an identity flag is generated at decoding, it is necessary to read out the identity flag prior to anchor information at decoding, and a data amount of information of the identity flag is small. Therefore, the identity flag is stored in a low capacity memory. Also, when the identity flag is generated at coding, because the information of the identity flag is included in a coded stream, it is not necessary to store the information in the low capacity memory. Also, because the identity count value is stored, in the anchor information storage unit with the anchor information whose identity count value indicates a succession, it is not necessary to store the identity count value in the low capacity memory.

In storing in the anchor information storage unit, it is necessary to read out anchor information of a corresponding anchor block of a target block to be decoded in accordance with the identity flag when the identity flag is used. Therefore, it is necessary to store the anchor information of all of the anchor blocks of an anchor picture in the anchor information storage unit. However, when an identity count value is used, the held anchor information is stored with the identity count value in the anchor information storage unit. Therefore, only the identity count value and the anchor information of a part of the blocks are stored in the anchor information storage unit.

As for the influence of a stream, it is not necessary to add a bit to a coded stream by determining identity of anchor information at decoding and generating the identity identification information. That is, it can also be reduced to read out the anchor information by using the coded stream generated by a conventional image coding apparatus. However, when the identity identification information is generated by determining identity of anchor information at coding, a bit is added because the identity flag is included in the coded stream.

As for the restriction of an anchor picture, when the identity flag is used, there is no restriction of the anchor picture. However, when the identity count value is used, the anchor information is not stored for each block. Therefore, if the anchor picture is switched in the middle of successive anchor information of blocks, correct anchor information cannot be acquired. Therefore, it is necessary to provide the restriction of an anchor picture.

Further, when the identity identification information is generated at coding, a determination criterion whether the anchor information can he considered identical can be set in consideration of image quality and the like. For example, with respect to the anchor information of the target block to be decoded used at coding and the anchor information used for the previous block, it is considered identical when a difference between motion vectors is a predetermined threshold or less. In such a case, it is considered identical even if the difference between the motion vectors is large where the threshold is increased but there is less deterioration of image quality or the like. Therefore, more blocks whose anchor information does not need to be read out can be set while the influence of image quality is reduced. Further, assume that it is considered identical when a difference between motion vectors is a threshold or less and the identity identification information is generated. In such a case, the identity flag is generated even if the difference between the motion vectors is the threshold or less because the identity is not satisfied where the deterioration of image quality is increased, and the deterioration exceeds a predetermined level by using the anchor information of the previous block. In this way, it can be controlled to read out the anchor information from the anchor information storage unit in such a way that the deterioration of image quality does not exceed the predetermined level, Also, when the identity identification information is generated at decoding, occurrence of the deterioration of image quality of a decoded image can be prevented due to the difference between the anchor information used at the decoding and used for the previous block if it is considered identical only when the motion vectors of the anchor information coincide with each other, for example.

### [4-2. Effect When Identity Identification Information Is Used]

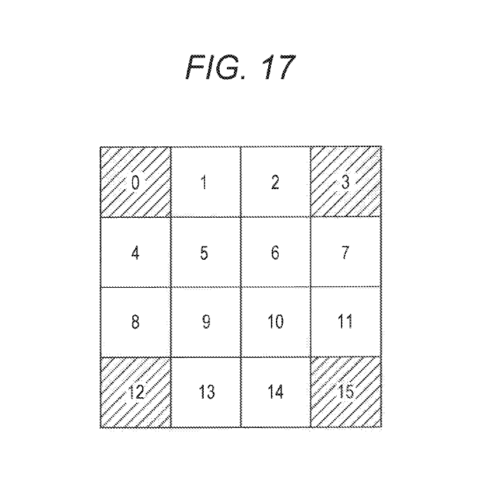

FIG. 17 shows an example illustrating a data amount of anchor information. For example, when an anchor block is formed of 4×4 blocks, and a DirectInferenceflag is set to be “1”, motion vectors of blocks (blocks shown with a slant line) at four corners and a reference index are used as the anchor information. Here, the anchor information of one anchor block is (14+12+6)×4=128 bits (16 bytes) where the motion vector in the horizontal direction is 14 bits, the motion vector in the vertical direction is 12 bits, and the reference index is 6 bits. That is, when K blocks occur, whose anchor information does not need to be read out by continuously using the anchor information of the previous block, data of 16×K bytes can be reduced in reading out anchor information from the anchor information storage unit 25. Note that, when the DirectInferenceflag is set to be “0”, all of the motion vectors and anchor indexes of the 4×4 blocks are used as the anchor information.

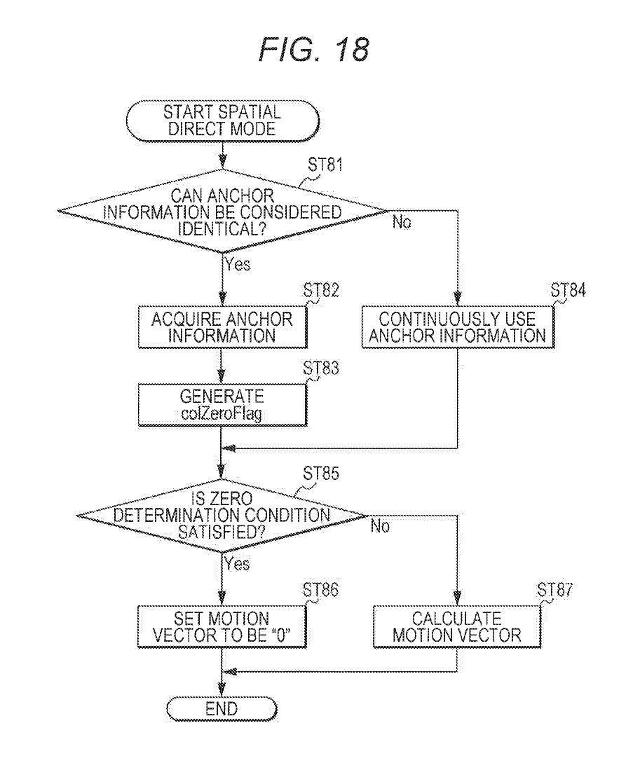

FIG. 18 is a flowchart showing an outline operation when a motion vector is calculated in a spatial direct mode. In step ST81, the motion compensation unit 24 determines whether anchor information can be considered identical to anchor information of a previous block. The motion compensation unit 24 proceeds to step ST82 when the anchor information cannot be considered identical to the anchor information of the previous block based on the identity identification information, whilst proceeds to step ST84 when the anchor information can be considered identical.

In step ST82, the motion compensation unit 24 acquires anchor information. The motion compensation unit 24 acquires anchor information of an anchor block corresponding to a target block to be decoded from the anchor information storage unit 25 and proceeds to step ST83.

In step ST83, the motion compensation unit 24 generates a colZeroFlag. The motion compensation unit 24 generates the colZeroFlag based on the acquired anchor information and proceeds to step ST85.

The colZeroFlag is information defined in each block of a P picture by H.264/AVC standard and indicates whether there is a motion of an image of a block. The colZeroFlag is “1” when all of the followings are “True”, otherwise, the colZeroFlag is “0”.

(a) A reference picture that is a minimum reference picture number in a L1 prediction is a short-term reference picture.

(b) The reference picture number of the reference picture with respect to an anchor block is 0. That is, an anchor picture as the reference picture is positioned later in the display order and closest to the target picture to be decoded.

(c) Horizontal and vertical components of a motion vector of the anchor block are both a value between −1 to 1.

In step ST84, the motion compensation unit 24 continuously uses anchor information. The motion compensation unit 24 continuously uses the anchor information of the previous block and proceeds to step ST85. That is, the motion compensation unit 24, unlike step ST83, continuously uses the colZeroFlag generated based on the anchor information of the previous block by continuously using the anchor information of the previous block without generating the colZeroFlag.

In step ST85, the motion compensation unit 24 determines whether a zero determination condition of a motion vector is satisfied. The motion compensation unit 24 proceeds to step ST86 because the zero determination condition is satisfied when, for example, the colZeroFlag is “1”, whilst proceeds to step ST87 because the zero determination condition is not satisfied when the colZeroFlag is “0”.

In step ST86, the motion compensation unit 24 sets the motion vector to be “0”. The motion compensation unit 24 sets both of the horizontal and vertical components of the motion vector of the target block to be decoded to be “0” and terminates the calculation of the motion vector.

In step ST87, the motion compensation unit 24 performs a motion vector calculation process. The motion compensation unit 24 performs, for example, a median prediction and sets a median of the motion vectors of adjacent blocks to be a prediction motion vector. Further, the motion compensation unit 24 calculates a motion vector of the target block to be decoded by adding a difference motion vector to the prediction motion vector and terminates the calculation of the motion vector.

In this way, it is not necessary to generate the colZeroFlag in the spatial direct mode by continuously using the anchor information of the previous block, whereby the process can be reduced.

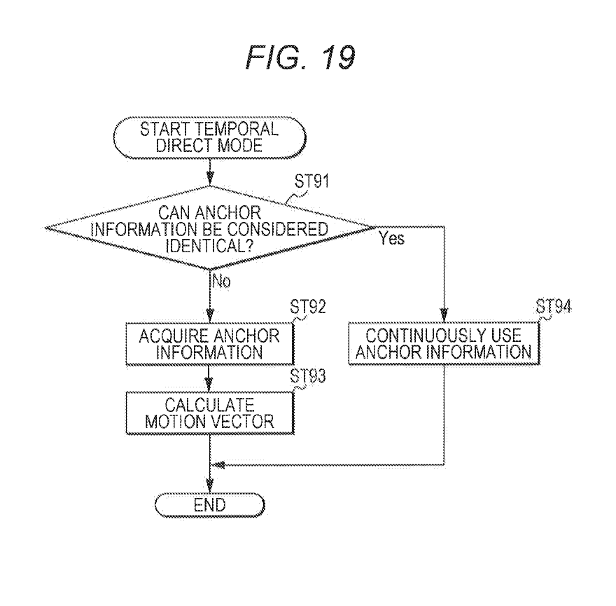

FIG. 19 is a flowchart, showing an outline operation when a motion vector is calculated in a temporal direct mode.

In step ST91, the motion compensation unit 24 determines whether anchor information can be considered identical to anchor information of a previous block. The motion compensation unit 24 proceeds to step ST92 when the anchor information cannot be considered identical to the anchor information of the previous block based on the identity identification information, whilst, proceeds to step ST94 when the anchor information can be considered identical.

In step ST92, the motion compensation unit 24 acquires anchor information. The motion compensation unit 24 acquires anchor information of an anchor block corresponding to a target block to be decoded from the anchor information storage unit 25 and proceeds to step ST93.

In step ST93, the motion compensation unit 24 calculates a motion vector. The motion compensation unit 24 calculates a motion vector based on the acquired anchor information. That is, as shown by H.264/AVC standard, a time interval between a target picture to be decoded and a picture to be referenced in a L0 prediction and a time interval between the target picture to be decoded and a picture to be referenced in a L1 prediction are obtained based on the reference index indicated in the anchor information. Further, a motion vector of the target block to be decoded is calculated based on the two time intervals and the motion vector indicated in the anchor information.

In step ST94, the motion compensation unit 24 continuously uses anchor information. The motion compensation unit 24 continuously uses the anchor information of a previous block. That is, the motion compensation unit 24 continuously uses the motion vector calculated based on the anchor information of the previous block without calculating the motion vector in step ST93 by continuously using the anchor information of the previous block.

In this way, in the temporal direct mode, it is not necessary to calculate the motion vector by continuously using the anchor information of the previous block, whereby the process can be reduced.

Further, when the anchor information of the target block to be decoded can be considered identical to the anchor information of the previous block according to the identity identification information, it is more effective to use the anchor information of the previous block in the following cases.

For example, when the anchor picture is an I picture or a slice of the anchor block is an I slice, the motion vector of the anchor information is “0” and the reference index of the anchor information is “−1”. Therefore, when the anchor picture is the I picture, it is not necessary to read out the anchor information. Also, in a case where the anchor picture includes an I slice, a P slice, or the like, and when the anchor information is read out in a first block of a slice and the slice is the I slice, it is not necessary to read out the anchor information thereafter. It is also effective when the size of a macro-block is expanded and the size of a block in the horizontal direction becomes larger. For example, when the length of the macroblock in the horizontal direction becomes double and this block is used as an anchor block, the size of this anchor block is equivalent to the size of two successive blocks that has one time length in the horizontal direction. That is, because the anchor information of the target block to be decoded and the anchor information of the previous block is identical, it can be reduced to read out the anchor information. Also, for example, when a pan/tilt, operation of an image pickup apparatus is performed and a motion is caused on a still background in a captured image, motion vectors of blocks indicating the image of the background become identical. Therefore, there are many cases wherein the anchor information of the previous block can be continuously used in the blocks of the background part, and therefore, it can be reduced to read out the anchor information.

### [5. A Case of a Software Process]

The series of processes described in the specification can be executed by hardware, software, or a combined configuration thereof. When a process is executed by the software, a program in which a process sequence is recorded is installed in a memory within a computer incorporated into dedicated hardware, and is executed. Alternatively, the program can be installed into a general purpose computer capable of executing various processes, and can be executed.

For example, the program can be recorded in advance on a hard disk or a ROM (read only memory) as a recording medium. Alternatively, the program can be temporarily or permanently stored (recorded) in a removable recording medium such as a flexible disk, a CD-ROM (compact disc read only memory), an MO (magneto optical) disk, a DVD (digital versatile disc), a magnetic disk, and a semiconductor memory. Such a removable recording medium can be provided as so-called package software.

Note that the program can be, other than installed from the above-described removable recording medium to the computer, transmitted with wireless communication from a download site to the computer or transmitted with wired communication to the computer via a network such as a LAN (local area network) or the internet. The computer can receive the program transmitted in that manner and the program can be installed into a recording medium such as a built-in hard disk.

A step describing the program includes not only a time series process according to a described order, but also, if it is not necessarily a time series process, a process executed in parallel or individually.

### [6. An Example Applied to Electronic Devices]

Further, the present invention can be applied to an image coding apparatus and an image decoding apparatus used when reception is performed via a network medium such as satellite broadcasting, a cable TV (television), the internet, and a mobile phone, or when a process is performed on a storing medium such as an optical disk, a magnetic disk, and a flash memory.

The above-described information processing apparatus can be applied to any electronic devices. Hereinafter, an example will be described.

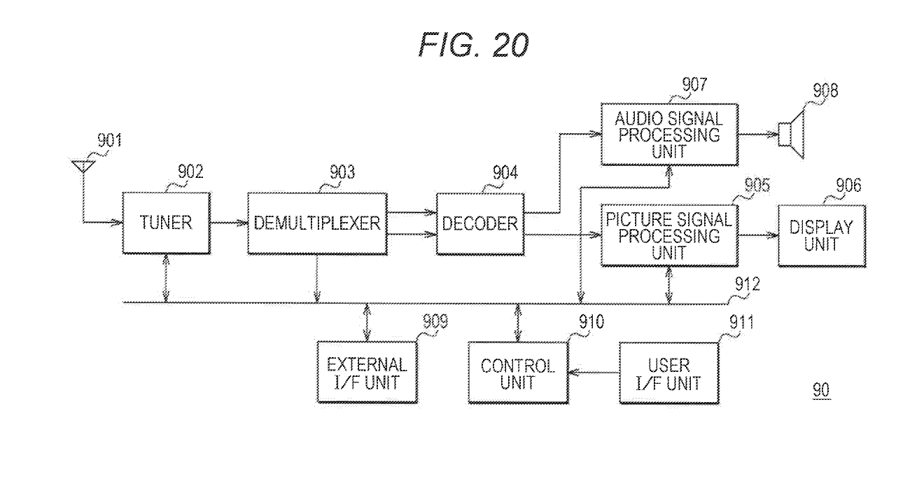

FIG. 20 exemplarily shows a schematic configuration of a television apparatus to which the present invention is applied. A television apparatus 90 includes an antenna 901, a tuner 902, a demultiplexer 903, a decoder 904, a picture signal processing unit 905, a display unit 906, an audio signal processing unit 907, a speaker 908, and an external interface unit 909. Further, the television apparatus 90 includes a control unit 910, a user interface unit 911, and the like.

The tuner 902 selects and demodulates as desired channel from among broadcasting signals received by the antenna 901 and outputs an obtained coded bit stream to the demultiplexer 903.

The demultiplexer 903 extracts a packet of a picture or an audio of a target program to be viewed from the coded bit stream and outputs data of the extracted packet to the decoder 904. Also, the demultiplexer 903 supplies a packet of data such as an EPG (electronic program guide) to the control unit 910. Note that the demultiplexer or the like cancels a scramble when the scramble has been performed.

The decoder 904 performs a decoding process of a packet, outputs picture data generated by the decoding process to the picture signal processing unit 905, and outputs audio data to the audio signal processing unit 907.

The picture signal processing unit 905 performs noise reduction or as picture process and the like in accordance with a user setting with respect to the picture data. The picture signal processing unit 905 generates picture data of a program to be displayed on the display unit 906 or image data processed based on an application supplied via a network. Also, the picture signal processing unit 905 generates picture data for displaying a menu screen of item selection and the like and superimposes the picture data on the picture data of the program. The picture signal processing unit 905 generates a driving signal based on the generated picture data and drives the display unit 906.

The display unit 906 drives a display device (for example, a crystal display device and the like) based on a driving signal from the picture signal processing unit 905, and displays a picture of the program.

The audio signal processing unit 907 performs predetermined processes such as noise reduction with respect to audio data, performs a D/A conversion process or an amplification process of the processed audio data, and outputs an audio by supplying the data to the speaker 908.

The external interface unit 909 is an interface for connecting with an external device, or a network and performs data transmission/reception of picture data, audio data, and the like.

The user interface unit 911 is connected to the control unit 910, The user interface unit 911 is configured from an operation switch, a remote control signal reception unit, and the like, and supplies, to the control unit 910, an operational signal in accordance with a user operation.

The control unit 910 is configured from a CPU (central processing unit), a memory, and the like. The memory stores a program executed by the CPU, various data necessary for the CPU to perform a process, EPG data, data acquired via the network, and the like. The program stored in the memory is read out and executed by the CPU at a predetermined timing such as at the time of startup of the television apparatus 90. The CPU controls various parts by executing the program so that the television apparatus 90 can operate in accordance with the user operation.

Note that the television apparatus 90 includes a bus 912 for connecting the control unit 910 with the tuner 902, the demultiplexer 903, the picture signal processing unit 905, the audio signal processing unit 907, the external interface unit 903, and the like.

In the television apparatus with such a structure, a function of the information processing apparatus (information processing method) of the present invention is provided in the decoder 904. Therefore, when a coded stream is decoded and decoded image data is generated, the decoding process can be performed by efficiently using anchor information.

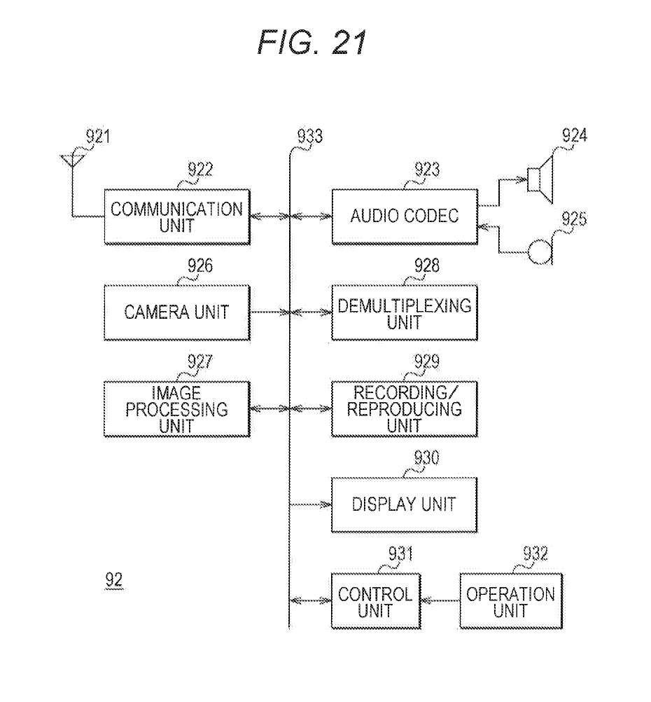

FIG. 21 exemplarily shows a schematic configuration of a mobile phone to which the present invention is applied. A mobile phone 92 includes a. communication unit 922, an audio codec 923, a camera unit 926, an image processing unit 927, a demultiplexing unit 928, a recording/reproducing unit 929, a display unit 930, and a control unit 931. These units are connected to each other via a bus 933.

Further, an antenna 921 is connected to the communication unit 922, and a speaker 924 and a microphone 925 are connected to an audio codec 923. Further, an operation unit 932 is connected to the control unit 931.

The mobile phone 92 performs, in various modes such as an audio telephone call mode or a data communication mode, various operations such as transmission/reception of an audio signal, transmission/reception of an electronic mail or image data, image shooting, and data recording.

In the audio telephone call mode, an audio signal generated in microphone 925 is subjected to (conversion to audio data and data compression in the audio codec 923 and is supplied to the communication unit 922. The communication unit 922 performs a modulation process, a frequency conversion process, and the like of the audio data and generates a transmission signal. Further, the communication unit 922 supplies the transmission signal to the antenna 921 and transmits the signal to a. base station (not shown). Further, the communication unit 922 performs amplification, a frequency conversion process, and a demodulation process of the received signal received by the antenna 921, and supplies an obtained audio data to the audio codec 923. The audio codec 923 performs data decompression or conversion to an analog audio signal of the audio data and outputs the data to the speaker 924.

Also, when mail transmission is performed in the data communication mode, the control unit 931 receives character data input by an operation of the operation unit 932 and displays the input character on the display unit 930. Further, the control unit 931 generates mail data based on a user instruction and the like by the operation unit 932 and supplies the data to the communication unit 922. The communication unit 922 performs a modulation process, a frequency conversion process, and the like of the mail data and transmits an obtained transmission signal from the antenna 921. Further, the communication unit 922 performs amplification, a frequency conversion process, a demodulation process, and the like of the received signal received by the antenna 921 and restores the mail data. The mail data is supplied to the display unit 930 and a content of the mail is displayed,

Note that the mobile phone 92 can store the received mail data in a storage medium in the recording/reproducing unit 929. The storage medium is an arbitrary rewritable storage medium. For example, examples of the storage medium include a semiconductor memory such as a RAM and a built-in flash memory, and a removable media such as a hard disk, a magnetic disk, a magneto-optical disk, an optical disk, a USB memory, and a memory card.

When image data is transmitted in the data communication mode, the image data generated in the camera unit 926 is supplied to the image processing unit 927. The image processing unit 927 performs a coding process of the image data, and generates coded data.

The demultiplexing unit 928 multiplexes the coded data generated in the image processing unit 927 and the audio data supplied from the audio codec 923 by a predetermined method and supplies the multiplexed data to the communication unit 922. The communication unit 922 performs a modulation process, a frequency conversion process, and the like of the multiplexed data and transmits an obtained transmission signal to the antenna 921. Also, the communication unit 922 performs amplification, a frequency conversion process, a demodulation process, and the like of the transmission signal received by the antenna 921 and restores the multiplexed data. The multiplexed data is supplied to the demultiplexing unit 928. The demultiplexing unit 928 demultiplexes the multiplexed data, supplies coded data to the image processing unit 927, and supplies audio data to the audio codec 923. The image processing unit 927 performs a decoding process of the coded data and generates image data. The image data is supplied to the display unit 930 and a received image is displayed. The audio codec 923 converts the audio data into an analog audio signal, supplies the audio signal to the speaker 924, and outputs the received audio.

In a mobile phone device with such a structure, a function of the information processing apparatus (information processing method) of the present invention is provided to the image processing unit 927. Therefore, when a coded stream is decoded and decoded image data is generated in communicating image data, the decoding process can be performed by efficiently using anchor information.

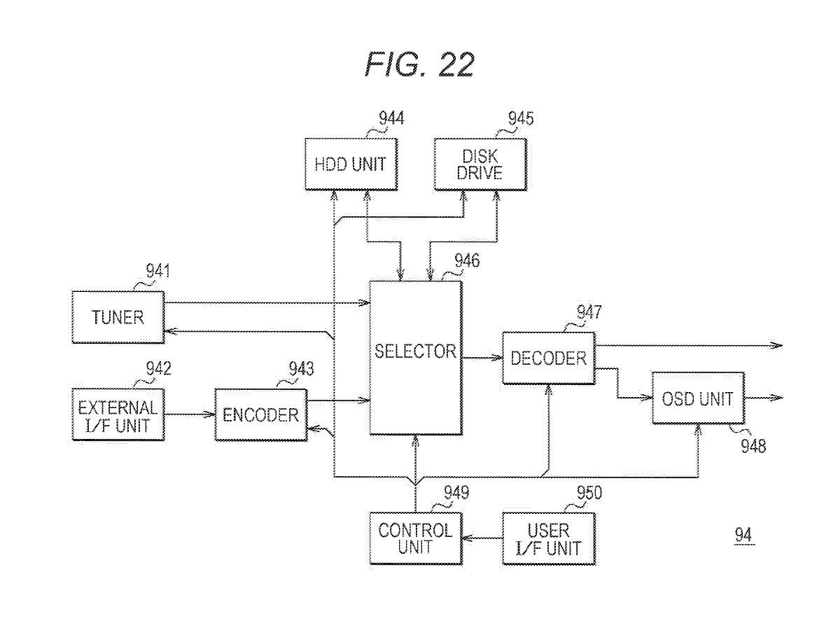

FIG. 22 exemplarily shows a schematic configuration of a recording/reproducing apparatus to which the present invention is applied. The recording/reproducing apparatus 94 records audio data and video data of a received broadcasting program on a recording medium and provides the recorded data to a user in accordance with a user instruction. Also, the recording/reproducing apparatus 94 acquires audio data and video data from other apparatus for example and can record the acquired data on a recording medium. Further, the recording/reproducing apparatus 94 can display an image on and output an audio from a monitor apparatus or the like by decoding and outputting the video data or the audio data recorded on the recording medium.

The recording/reproducing apparatus 94 includes a tuner 941, an external interface unit 942, an encoder 943, an HDD (hard disk drive) unit 944, a disk drive 945, a selector 946, a decoder 947, an OSD (on-screen display) unit 948, a control unit 949, and a user interface unit 950.

The tuner 941 selects a desired channel from among broadcasting signals received by an antenna (not shown). The tuner 941 outputs, to the selector 946, a coded bit stream obtained by demodulating the received signal of the desired channel.

The external interface unit 942 is configured from at least any one of an IEEE1394 interface, a network interface unit, a USB interface, a flash memory interface, and the like. The external interface unit 942 is an interface for connecting with an external device, a network, a memory card, and the like and performs data reception of picture data, audio data, and the like to be recorded.

The encoder 943 performs coding by a predetermined method, when the picture data or the audio data supplied from the external interface unit 942 is not coded and outputs a coded bit stream to the selector 946.

The HDD unit 944 records, on a built-in hard disk, data of contents such, as a picture and an audio, various programs, and other data, and reads out the data from the hard disk at reproduction.

The disk drive 945 records and reproduces a signal with respect to a mounted optical disk. The optical disk is, for example, a DVD disk (a DVD-video, a DVD-RAM, a DVD-R, a DVD-RW, a DVD+R, a DVD+RW, and the like), a Blu-ray disk, and the like.

The selector 946 selects any one of coded bit streams from the tuner 941 or the encoder 943 and supplies the selected stream to either the HDD unit 944 or the disk drive 945 at recording of a picture or an audio. Also, the selector 946 supplies the coded bit stream, output from the HDD unit 944 or the disk drive 945 to the decoder 947 at reproducing a picture or an audio.

The decoder 947 performs a decoding process of the coded bit stream. The decoder 947 supplies generated picture data, by performing the decoding process to the OSD unit 948. Also, the decoder 947 outputs generated audio data by performing the decoding process.

The OSD unit 948 generates picture data for displaying a menu screen of item selection and the like and superimposes and outputs the generated picture data on the picture data output from the decoder 947.

The user interface unit 950 is connected to the control unit 949. The user interface unit 950 is configured from an operation switch, a remote control signal receiving unit, and the like, and supplies an operation signal in accordance with a user operation to the control unit 949.

The control unit 949 is configured from a CPU, a memory, and the like. The memory stores a program executed by the CPU and various programs necessary for the CPU to perform a process, The program stored in the memory is read out and executed by the CPU at a predetermined timing such as at the time of startup of the recording/reproducing apparatus 94, The CPU controls various parts by executing the program so that the recording/reproducing apparatus 94 can operate in accordance with a user operation.

In the recording/reproducing apparatus with such a structure, a function of the information processing apparatus (information processing method) of the present invention is provided to the encoder 943. Therefore, when decoded image data is generated by decoding a coded stream, the decoding process can be performed by efficiently using anchor information.

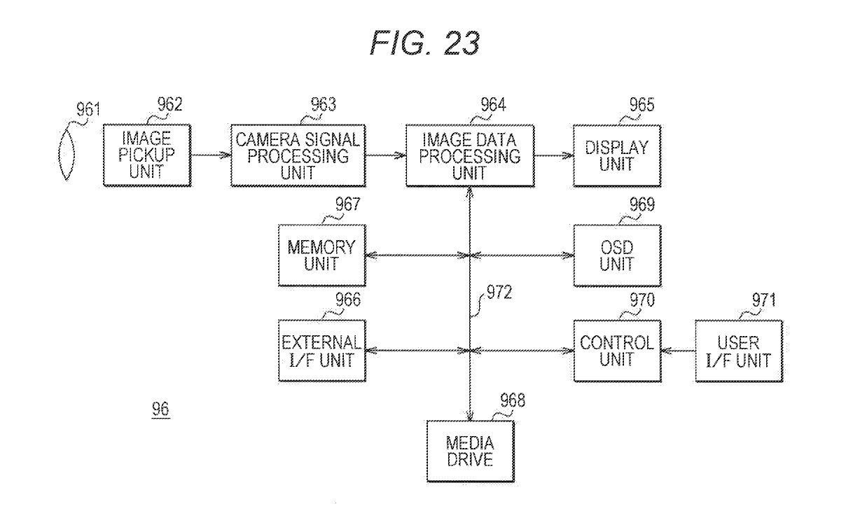

FIG. 23 exemplarily shows a schematic configuration of an image pickup apparatus to which the present invention is applied. The image pickup apparatus 96 captures an object, displays an image of the object on a display unit, and records the image on a recording medium as image data.

The image pickup apparatus 96 includes an optical block 961, an image pickup unit 962, a camera signal processing unit 963, an image data processing unit 964, a display unit 965, an external interface unit 966, a memory unit 967, a media drive 968, an OSD unit 969, and a control unit 970. Further, a user interface unit 971 is connected to the control unit 970. Further, the image data processing unit 964, the external interface unit 966, the memory unit 967, the media drive 968, the OSD unit 969, the control unit 970 and the like are connected via a bus 972.

The optical block 961 is configured from a focus lens, a diaphragm mechanism, and the like. The optical block 961 images an optical image of the object on an imaging plane of the image pickup unit 962. The image pickup unit 962 is configured from a CCD or a CMOS image sensor, generates an electric signal in accordance with the optical image by photoelectric effect, and supplies the generated signal to the camera signal processing unit 963.

The camera signal processing unit 963 performs various camera signal processes such as knee correction, gamma correction, and color correction with respect to the electric signal supplied from the image pickup unit 962. The camera signal processing unit 963 supplies image data subjected to the camera signal processes to the image data processing unit 964.

The image data processing unit 964 performs a coding process of the image data supplied from the camera signal processing unit 963. The image data processing unit 964 supplies the coded data generated by performing the coding process to the external interface unit 966 and the media drive 968. Further, the image data processing unit 964 performs a decoding process of the coded data supplied from the external interface unit 966 and the media drive 968. The image data processing unit 964 supplies image data generated by performing the decoding process to the display unit 965. Further, the image data processing unit 964 supplies the image data supplied from the camera signal processing unit 963 to the display unit 965, superimposes data for display acquired from the OSD unit 969 on the image data, and supplies the superimposed data to the display unit 965.

The OSD unit 969 generates the data for display such as a menu screen composed of a symbol, a character, or a figure, and an icon and outputs the data to the image data processing unit 964.

The external interface unit 966 is configured from, for example, a USB input/output terminal and the like and is configured to be connected to a printer when an image is printed out. Also, a drive is connected to the external interface unit 966 as needed, and a removal medium such as a magnetic disk and an optical disk is properly attached to the external interface unit 966, and a computer program read out from the drive or the medium is installed into the external interface unit 966 as needed. Further, the external interface unit 966 has a network interface connected to a predetermined network such as a LAN and the internet. The control unit 970 is capable of reading out the coded data from the memory unit 967 in accordance with an instruction from the user interface unit 971, for example, and supplying the data from the external interface unit 966 to other devices via the network. Further, the control unit 970 is capable of acquiring coded data or image data via external interface unit 966, which is supplied from other devices via the network, and supplying the acquired data to the image data processing unit 964.

Examples of the recording medium driven by the media drive 968 include an arbitrary rewritable removable medium such as a magnetic disk, a magneto-optical disk, an optical disk, and a semiconductor memory. Also, the recording medium may employ any type of removable media, and may be a tape device, a disk, or a memory card. Of course, a contactless IC card or the like may be employed.

Further, the media drive 968 and the recording medium can be integrated and can be, for example, configured from a non portable storage medium such as a built-in hard disk drive and an SSD (solid state drive).

The control unit 970 is configured from a CPU, a memory, and the like, The memory stores a program executed by the CPU, various data necessary for the CPU to perform a process, and the like. The program stored in the memory is read out and executed by the CPU at a predetermined timing such as at a time of start-up of the image pickup apparatus 96. The CPU controls various part by executing the program so that the image pickup apparatus 96 can operate in accordance with a user operation.

In the image pickup apparatus with such a structure, a function of the information processing apparatus (information processing method) of the present invention is provided to the image data processing unit 964. Therefore, when decoded image data is generated by decoding the coded data recorded on the memory unit 967, a recording medium, and the like, the decoding process can be performed by efficiently using anchor information.

Further, interpretation of the present invention should not be limited to the above-described embodiment of the invention. The embodiment of the invention exemplarily discloses the present invention and it is apparent that a person skilled in the art may modify or substitute the embodiment without departing from the scope of the present invention. That is, the claims should be considered in order to judge the scope of the present invention.

### INDUSTRIAL APPLICABILITY

The information processing apparatus and the information processing method of the present invention acquire, when anchor information to be used in a decoding process of a target block to be decoded does not satisfy an identity condition with anchor information used for a previous block, anchor information of an anchor block corresponding to the target block to be decoded from an anchor information storage unit. Also, when the identity condition is satisfied, the anchor information used for the previous block is continuously used. The decoding process is performed using the acquired anchor information or the anchor information to be continuously used. Therefore, it is not necessary to acquire the anchor information of the corresponding anchor block from the anchor information storage unit for each target block to be decoded, whereby the anchor information can be efficiently used. Therefore, the present invention is suitable for an electronic device that performs a decoding process of image data.

### REFERENCE SIGNS LIST

10 Image decoding apparatus
11 and 57 Accumulation buffer
12 Lossless decoding unit
13 and 61 Inverse quantization unit
14 and 62 Inverse orthogonal transformation unit
15 and 63 Adding unit
16 and 64 Deblocking filter
17 and 52 Screen rearrangement buffer
18 D/A conversion unit
21 and 65 Frame memory
22, 26 and 66 Selector
23 and 71 Intra prediction unit
24 Motion compensation unit
25 Anchor information storage unit.
50 Image coding apparatus
51 A/D conversion unit
53 Subtraction unit
54 Orthogonal transformation unit
55 Quantization unit
56 Lossless coding unit
58 Rate control unit
72 Motion prediction/compensation unit
73 Prediction image/optimum mode selection unit
90 Television apparatus
92 Mobile phone
94 Recording/reproducing apparatus
96 Image pickup apparatus
721 Motion vector detection unit
722 Prediction mode determination unit
723 Prediction mode storage unit
724 Anchor information generation/storage unit
725 Information generation unit

1. An information processing apparatus, comprising:
an anchor information storage unit configured to store anchor information; and
an image decoding unit configured to acquire anchor information of an anchor block corresponding to a target block to be decoded from the anchor information storage unit when anchor information to be used in a decoding process of the target block to be decoded does not satisfy an identity condition with anchor information used for a previous block, to allow the anchor information used for the previous block to be continuously used when the identity condition is satisfied, and to perform the decoding process using the acquired anchor information or the anchor information allowed to be continuously used.

2. The information processing apparatus according to claim 1, wherein the image decoding unit acquires the anchor information or continuously uses the anchor information of the previous block based on identity identification information determining whether the identity condition is satisfied.

3. The information processing apparatus according to claim 2, wherein, with respect to a picture to be used as an anchor picture and having been subjected to the decoding process in the image decoding unit, the identity identification information is information generated based on anchor information generated for each block of the picture.

4. The information processing apparatus according to claim 3, wherein the identity identification information is an identity flag indicating whether the anchor information is considered identical to the anchor information of the previous block.

5. The information processing apparatus according to claim 4, wherein the image decoding unit stores the identity flag in a storage unit separately provided from the anchor information storage unit, and stores the generated anchor information of the picture to be used as an anchor picture in the anchor information storage unit.

6. The information processing apparatus according to claim 3, wherein the identity identification information is an identity count value indicating the number of successive blocks whose anchor information is considered identical.

7. The information processing apparatus according to claim 6, wherein the image decoding unit causes the identity count value and the anchor information considered identical by the identity count value to correspond to each other in order of blocks and stores the identity count value and the anchor information in the anchor information storage unit.

8. The information processing apparatus according to claim 2, wherein the identity identification information is information generated based on the anchor information used at coding of the target block to be decoded and the anchor information used at coding of the previous block.

9. The information processing apparatus according to claim 8, wherein, with respect to anchor information used at coding of the target block to be decoded and anchor information used at coding of the previous block, the identity identification information is generated by considering the two pieces of anchor information to be identical when a difference between motion vectors is a predetermined threshold or less, and by considering the two pieces of anchor information not to be identical when deterioration of image quality caused by the coding exceeds a predetermined level.

10. The information processing apparatus according to claim 8, wherein the image decoding unit extracts the identity identification information from a coded stream of image data.

11. An information processing method, comprising the steps of:
acquiring anchor information of an anchor block corresponding to a target block to be decoded from an anchor information storage unit for storing anchor information when anchor information to be used in a decoding process of the target block to be decoded does not satisfy an identity condition with anchor information used for a previous block;
continuously using the anchor information used for the previous block when the identity condition is satisfied; and
performing the decoding process using the acquired anchor information or the anchor information to be continuously used.
